(19) United States
(12) Patent Application Publication
(10) Pub. No.: US 2022/0164071 A1
(43) Pub. Date: May 26, 2022

(54) METHOD AND DEVICE FOR PROVIDING USER-SELECTION-BASED INFORMATION

(71) Applicant: Samsung Electronics Co., Ltd., Suwon-si, Gyeonggi-do (KR)

(72) Inventors: Doosoon CHOI, Suwon-si (KR); Jaeyung YEO, Suwon-si (KR)

(21) Appl. No.: 17/436,894

(22) PCT Filed: Feb. 24, 2020
(86) PCT No.: PCT/KR2020/002636

§ 371 Date: Sep. 7, 2021

(30) Foreign Application Priority Data
Mar. 5, 2019 (KR) 10-2019-0025262

(51) Int. Cl. G06F 3/0481; G06Q 10/10; G06F 3/0484

(52) U.S. Cl. CPC G06F 3/0481; G06N 20/00; G06F 3/0484; G06Q 10/1097

(57) ABSTRACT

A method and an electronic device for providing a user with user-selection-based information is provided. The electronic device includes storing a first application program including a first user interface, and a second application program including a second user interface. The electronic device receives a first user input of requesting a task using the first application program, display, on a display, the first user interface including a result of performing the task, receive a second user input of storing the task, may store information related to the task in a memory based on at least a part of the second user input, receive a third user input of executing the second application program after the information is stored, and provide the stored information related to the task on a part of an area of the second user interface, in response to the third user input.

### CROSS-REFERENCE TO RELATED APPLICATION(S)

This application is a U.S. National Stage application under 35 U.S.C. § 371 of an International application number PCT/KR2020/002636, filed on Feb. 24, 2020, which is based on and claims priority of a Korean patent application number 10-2019-0025262, filed on Mar. 5, 2019, in the Korean Intellectual Property Office, the disclosure of which is incorporated by reference herein in its entirety.

### BACKGROUND

### 1. Field

The disclosure relates to a method and a device which generate user selection-based information in an electronic device and provide the user selection-based information to a user.

### 2. Description of Related Art

Recently, with the development of the digital technology, various types of electronic devices, such as a mobile communication terminal, a smart phone, a tablet personal computer (PC), a notebook, a wearable device, a digital camera, a personal computer and/or an Internet of things (IoT) device, are widely used.

Recently, an electronic device provides an intelligence assistant application program (or function) for the same function (or service) as a role of an artificial intelligent (AI) secretary, and constructs and provides various types of information necessary for (or related to) a user in a card form (e.g., an information card) through a page (e.g., a personal page) (or a user interface (UI)) related to an intelligence assistant. For example, the electronic device may analyze context of a user, may identify information necessary for the user among several types of information based on place, time or event information of the user, may construct the identified information in a card form, and may provide the user with the constructed information through a related page.

The above information is presented as background information only to assist with an understanding of the disclosure. No determination has been made, and no assertion is made, as to whether any of the above might be applicable as prior art with regard to the disclosure.

### SUMMARY

However, the electronic device simply analyzes context of a user, and provides simple information which is related to the context of the user, but may be not related to intent of the user. Accordingly, an electronic device of the related art has limitations in accurately providing personalized (or specialized) information required (or intended) by a user, and has limitations in providing information as information which is specialized and has a meaning (or is meaningful) to the user. Accordingly, an intelligence assistant application program (or function) has very low utilization because it provides an information card in which related information is simply collected, not information meaningful to a user, in providing an information card including simple information.

Aspects of the disclosure are to address at least the above-mentioned problems and/or disadvantages and to provide at least the advantages described below. Accordingly, an aspect of the disclosure is to provide a method and a device which construct and provide meaningful information more personalized (or specialized) for a user, among several pieces of information, in a user interface having a personal page form which provides information necessary for the user in the form of an interface having a card form (e.g., an information card).

Another aspect of the disclosure is to provide a method and device, which can provide a scrap object (or a scrap interface) capable of obtaining (or scraping) information meaningful to a user, can scrap content explicitly intended by the user through the scrap object, and can provide personalized semantic-based information to the user based on information about the scraped content, in a user interface related to an application program.

Another aspect of the disclosure is to provide a method and device, which can construct a personal page interface based on an information card generated as information meaningful to a user and can provide the user with the information card of the personal page interface by recommending the information card according to priority (e.g., through order rearrangement) based on timing (e.g., a time, a place or an interest) necessary for the user.

Additional aspects will be set forth in part in the description which follows and, in part, will be apparent from the description, or may be learned by practice of the presented embodiments.

In accordance with an aspect of the disclosure, an electronic device is provided. The electronic device includes a display, at least one processor operatively coupled to the display, and a memory operatively coupled to the at least one processor. The memory is configured to store a first application program including a first user interface (UI) and a second application program including a second UI. The memory may store instructions, when being executed, enabling the at least one processor to receive a first user input to request a task using the first application program, display, on the display, the first UI including results of execution of the task, receive a second user input to store the task, store, in the memory, information related to the task based on at least some of the second user input, receive a third user input to execute the second application program after storing the information, and display, in some region of the second UI, the stored information related to the task in response to the third user input.

In accordance with another aspect of the disclosure, an operating method of the electronic device is provided. The operating method includes receiving a first user input to request a task using a first application program, displaying, on a display, a first user interface (UI) including results of execution of the task, receiving a second user input to store the task, storing, in a memory, information related to the task based on at least some of the second user input, receiving a third user input to execute a second application program after storing the information, and displaying, in some region of a second UI, the stored information related to the task in response to the third user input.

In order to address the aforementioned issues, various embodiments of the disclosure may include a computer-readable recording medium on which a program for executing the method in a processor is recorded.

According to the electronic device and the operating method thereof according to various embodiments of the disclosure, a content provider (CP) can construct a user interface (UI) (e.g., a UI including a scrap object (or a scrap interface)) in which content interested by a user (or semantic-based content personalized for the user) can be more easily added to an intelligence assistant. According to various embodiments of the disclosure, a user can scrap the user's interest (or content) (e.g., an object (or information) meaningful to the user) through a scrap object (or a scrap interface) of a UI about an application program (e.g., a 3^{rd} application program) of a content provider.

According to various embodiments of the disclosure, the electronic device can register an information card (e.g., a personalized semantic-based information card) with a personal page interface based on information (e.g., personalized semantic-based information) about an object scraped by a user, and can provide the information card (or related information of the information card) in a way suitable for an occasion in which the user requires the information card at the corresponding occasion.

According to various embodiments of the disclosure, the electronic device can construct and provide a personal page interface in the form of an information card (e.g., an interface having a card form) meaningful to a user. According to various embodiments of the disclosure, the information card may be reconstructed in various forms, such as a content type and/or an action type based on each of objects scraped by a user, and may be provided to the user.

According to various embodiments of the disclosure, a personal page interface consisting of an information card including personalized semantic-based information, not a personal page interface in which information related to context of a user is simply collected, can be provided to the user based on objects meaningfully scraped by the user. According to various embodiments of the disclosure, even in a personal page interface, an information card may be provided by changing priority of the information card based on timing (e.g., a time, a place or an interest) at which a user requires the information card or may be provided by recommending the information card.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 is a block diagram illustrating an electronic device in a network environment according to an embodiment of the disclosure;

FIG. 2 is a block diagram illustrating an integrated intelligence system according to an embodiment of the disclosure;

FIG. 3 is a diagram illustrating relationship information between a concept and an action being stored in a database according to an embodiment of the disclosure;

FIG. 4 is a diagram illustrating a screen in which a user equipment (UE) processes a voice input received through an intelligent app according to an embodiment of the disclosure;

FIG. 5 is a diagram illustrating a system which provides an information card in an electronic device according to an embodiment of the disclosure;

FIG. 6 is a flowchart illustrating an operating method of an electronic device according to an embodiment of the disclosure;

FIG. 7 is a flowchart illustrating an operating method of an electronic device according to an embodiment of the disclosure;

FIG. 8 is a diagram illustrating interactions between applications in an electronic device according to an embodiment of the disclosure;

FIGS. 9A and 9B are diagrams illustrating a card being constructed in an electronic device according to an embodiment of the disclosure;

FIGS. 10A, 10B, and 10C are diagrams illustrating cards being provided through a personal page interface in an electronic device according to various embodiments of the disclosure;

FIG. 11 is a flowchart illustrating an operating method of an electronic device according to an embodiment of the disclosure;

FIGS. 12, 13, and 14 are diagrams illustrating user interfaces including scrap objects according to various embodiments of the disclosure;

FIGS. 15 and 16 are diagrams illustrating user interfaces including scrap objects according to various embodiments of the disclosure;

FIGS. 17, 18, and 19 are diagrams illustrating a user interface according to various embodiments of the disclosure;

FIG. 20 is a flowchart illustrating an operating method of an electronic device 101 according to an embodiment of the disclosure; and

FIGS. 21 and 22 are diagrams illustrating a user interface which provides a card according to various embodiments of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

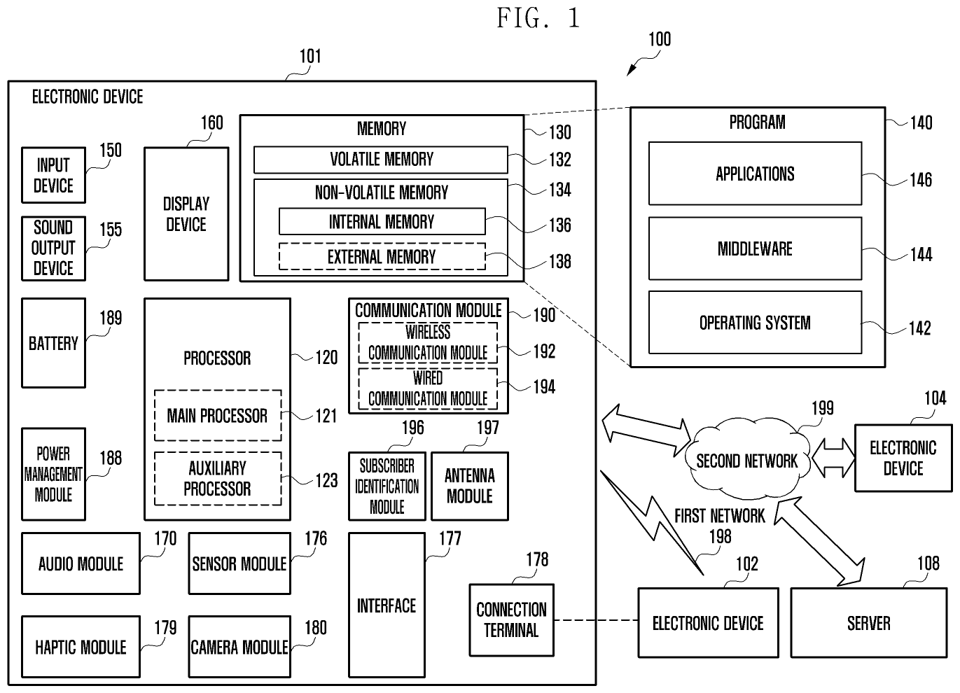

FIG. 1 is a block diagram illustrating an electronic device in a network environment according to an embodiment of the disclosure.

Referring to FIG. 1, an electronic device 101 in network environment 100 may communicate with an electronic device 102 via a first network 198 (e.g., a short-range wireless communication network), with an external electronic device 104 or a server 108 via a second network 199 (e.g., a long-range wireless communication network), or with the external electronic device 104 via the server 108, and may include a processor 120, a memory 130, an input device 150, a sound output device 155, a display device 160, an audio module 170, a sensor module 176, an interface 177, a haptic module 179, a camera module 180, a power management module 188, a battery 189, a communication module 190, a subscriber identification module (SIM) card 196, and an antenna module 197. At least one (e.g., the display device 160 or the camera module 180) of the components may be omitted from the electronic device 101, or one or more other components may be added in the electronic device 101. Some of the components may be implemented as single integrated circuitry. For example, the sensor module 176 (e.g., a fingerprint sensor, an iris sensor, or an illuminance sensor) may be implemented as embedded in the display device 160 (e.g., a display).

The processor 120 may execute, for example, software (e.g., a program 140) to control at least one other component (e.g., a hardware or software component) of the electronic device 101 coupled with the processor 120, and may perform various data processing or computation. The processor 120 may load a command or data received from another component (e.g., the sensor module 176 or the communication module 190) in a volatile memory 132, process the command or the data stored in the volatile memory 132, and store resulting data in a non-volatile memory 134. The processor 120 may include a main processor 121 (e.g., a central processing unit (CPU) or an application processor (AP)), and an auxiliary processor 123 (e.g., a graphics processing unit (GPU), an image signal processor (ISP), a sensor hub processor, or a communication processor (CP)) that is operable independently from, or in conjunction with, the main processor 121. Additionally or alternatively, the auxiliary processor 123 may be adapted to consume less power than the main processor 121, or to be specific to a function. The auxiliary processor 123 may be implemented as separate from, or as part of the main processor 121.

The auxiliary processor 123 may control at least some of functions or states related to at least one component (e.g., the display device 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). The auxiliary processor 123 (e.g., an image signal processor or a communication processor) may be implemented as part of another component (e.g., the camera module 180 or the communication module 190) functionally related to the auxiliary processor 123.

The memory 130 may store various data used by at least one component (e.g., the processor 120 or the sensor module 176) of the electronic device 101 and may include software (e.g., the program 140) and input data or output data for a command related thereto. The memory 130 may include the volatile memory 132 or the non-volatile memory 134.

The program 140 may be stored in the memory 130 as software, and may include an operating system (OS) 142, middleware 144, or an application 146.

The input device 150 may receive a command or data to be used by another component (e.g., the processor 120) of the electronic device 101, from the outside (e.g., a user) of the electronic device 101, and may include a microphone, a mouse, a keyboard, or a digital pen (e.g., a stylus pen).

The sound output device 155 may output sound signals to the outside of the electronic device 101 and may include a speaker or a receiver. The speaker may be used for general purposes, such as playing multimedia or playing record, and the receiver may be used for incoming calls and may be implemented in a separate from, or as part of the speaker.

The display device 160 may visually provide information to the outside (e.g., a user) of the electronic device 101 and may include a display, a hologram device, or a projector and control circuitry to control a corresponding one of the display, hologram device, and projector. The display device 160 may include touch circuitry adapted to detect a touch, or sensor circuitry (e.g., a pressure sensor) adapted to measure the intensity of force incurred by the touch.

The audio module 170 may convert a sound into an electrical signal and vice versa, and may obtain the sound via the input device 150, or output the sound via the sound output device 155 or a headphone of an external electronic device (e.g., an electronic device 102) directly (e.g., over wires) or wirelessly coupled with the electronic device 101.

The sensor module 176 may detect an operational state (e.g., power or temperature) of the electronic device 101 or an environmental state (e.g., a state of a user) external to the electronic device 101, and generate an electrical signal or data value corresponding to the detected state, and may include a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., over wires) or wirelessly, and may include a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102), and may include a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation, and may include a motor, a piezoelectric element, or an electric stimulator.

The camera module 180 may capture a still image or moving images and may include one or more lenses, image sensors, image signal processors, or flashes.

The power management module 188 may manage power supplied to the electronic device 101, and may be implemented as at least part of a power management integrated circuit (PMIC).

The battery 189 may supply power to at least one component of the electronic device 101, and may include a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the external electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. The communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a cellular network, the Internet, or a computer network (e.g., a LAN or a wide area network (WAN)). These various types of communication modules may be implemented as a single component (e.g., a single chip), or may be implemented as multi components (e.g., multi chips) separate from each other.

The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The antenna module 197 may transmit or receive a signal or power to or from the outside (e.g., the external electronic device) of the electronic device 101 and may include an antenna including a radiating element including a conductive material or a conductive pattern formed in or on a substrate (e.g., a PCB). The antenna module 197 may include a plurality of antennas. In such a case, at least one antenna appropriate for a communication scheme used in the communication network, such as the first network 198 or the second network 199, may be selected by the communication module 190 (e.g., the wireless communication module 192) from the plurality of antennas. The signal or the power may then be transmitted or received between the communication module 190 and the external electronic device via the selected at least one antenna. Another component (e.g., an RFIC) other than the radiating element may be additionally formed as part of the antenna module 197.

At least some of the aforementioned components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

Commands or data may be transmitted or received between the electronic device 101 and the external electronic device 104 via the server 108 coupled with the second network 199. Each of the external electronic devices 102 and 104 may be a device of a same type as, or a different type, from the electronic device 101.

All or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing, as at least part of a reply to the request. To that end, a cloud, distributed, or client-server computing technology may be used, for example.

Prior to describing various embodiments of the disclosure, an integrated intelligence system to which an embodiment can be applied will be described.

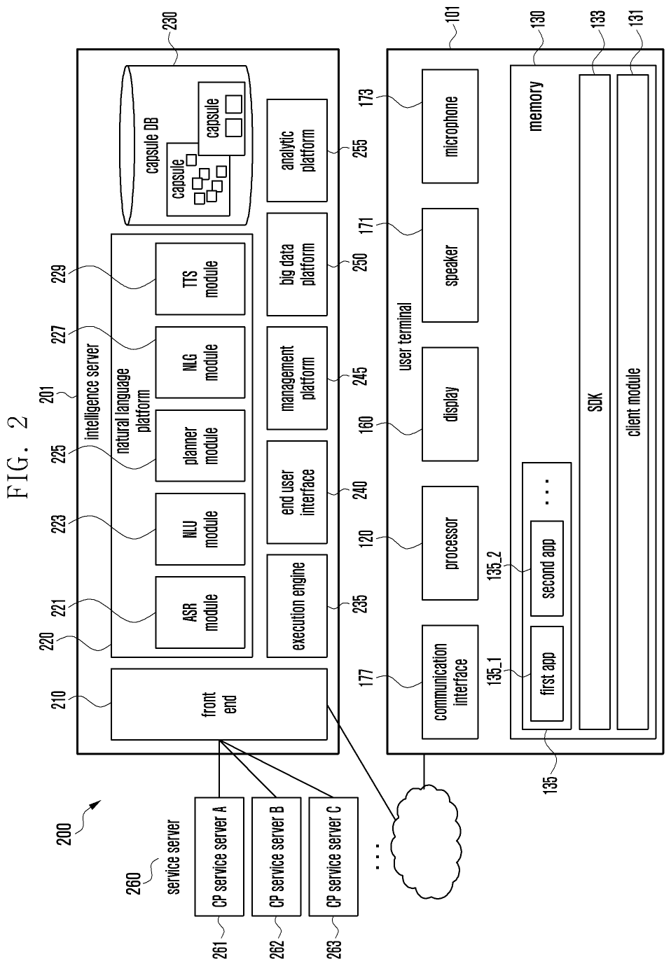

FIG. 2 is a block diagram illustrating an integrated intelligence system according to an embodiment of the disclosure.

Referring to FIG. 2, the integrated intelligence (or artificial intelligent (AI)) system 20 according to an embodiment may include a UE 101 (e.g., the electronic device 101 in FIG. 1), an intelligent server 201, and a service server 260.

The UE 101 according to an embodiment may be a terminal device (or the electronic device 101) that can be connected to the Internet, and may be, for example, a mobile phone, a smart phone, a personal digital assistant (PDA), a notebook computer, a television (TV), a major appliance or domestic appliance, a wearable device, a head mounted display (HMD), or a smart speaker.

According to an embodiment of the disclosure, the UE 101 may include a communication interface 177, a microphone 173, a speaker 171, a display 160, a memory 130, and a processor 120. The above-listed components may be operatively or electrically connected to each other.

According to an embodiment of the disclosure, the communication interface 177 may be configured to be connected to an external device to transmit and receive data to and from the external device. According to an embodiment of the disclosure, the microphone 173 may receive sound (e.g., user utterance) and may convert the received sound into electrical signals. According to an embodiment of the disclosure, the speaker 171 may output electrical signals as sound (e.g., voice). According to an embodiment of the disclosure, the display 160 may be configured to display images or videos. According to an embodiment of the disclosure, the display 160 may display a graphical user interface (GUI) of an app (or an application program) to be executed.

According to an embodiment of the disclosure, the memory 130 may store a client module 131, a software development kit (SDK) 133, and a plurality of apps 255. The client module 131 and the SDK 133 may configure a framework (or a solution program) for performing a general-purpose function. In addition, the client module 131 or the SDK 133 may configure a framework for processing a voice input.

According to an embodiment of the disclosure, the plurality of apps 255 may be a program for performing a designated function. According to an embodiment of the disclosure, the plurality of apps 255 may include a first app 135_1 and a second app 1352. According to an embodiment of the disclosure, each of the plurality of apps 255 may include a plurality of actions for performing designated functions. For example, the plurality of apps 255 may include at least one of an alarm app, a message app, or a schedule app. According to an embodiment of the disclosure, the plurality of apps 255 may be executed by a processor 120 to sequentially execute at least some of the plurality of actions.

According to an embodiment of the disclosure, the processor 120 may control the overall operation of the UE 101. For example, the processor 120 may be electrically connected to the communication interface 177, the microphone 173, the speaker 171, the display 160, and the memory 130 to perform designated operations.

According to an embodiment of the disclosure, the processor 120 may execute a program stored in the memory 130 to perform a designated function. For example, the processor 120 may execute at least one of the client module 131 or the SDK 133 to perform the following operation for processing a voice input. The processor 120 may control the operation of the plurality of apps 255 through, for example, the SDK 133. The following operation described as the operation of the client module 131 or the SDK 133 may be an operation by the execution of the processor 260.

According to an embodiment of the disclosure, the client module 131 may receive a voice input. For example, the client module 131 may generate a voice signal corresponding to a user utterance detected through the microphone 173. The client module 131 may transmit the received voice input to the intelligent server 201. According to an embodiment of the disclosure, the client module 131 may transmit state information of the UE 101 to the intelligent server 201 together with the received voice input. The state information may be, for example, execution state information of an app.

According to an embodiment of the disclosure, the client module 131 may receive a result corresponding to the received voice input. For example, the client module 131 may receive the result corresponding to the voice input from the intelligent server 201. The client module 131 may display the received result on the display 240.

According to an embodiment of the disclosure, the client module 131 may receive a plan corresponding to the received voice input. The client module 131 may display, on the display 240, a result obtained by executing a plurality of actions of an app according to the plan. For example, the client module 131 may sequentially display the execution results of the plurality of actions on the display. According to an embodiment of the disclosure, the UE 101 may display some of the results obtained by executing the plurality of actions on the display 240.

According to an embodiment of the disclosure, the client module 131 may receive a request for acquiring information used for calculating a result corresponding to the voice input from the intelligent server 201. The information used for calculating the result may be, for example, state information of the UE 101. According to an embodiment of the disclosure, the client module 131 may transmit the used information to the intelligent server 201 in response to the request.

According to an embodiment of the disclosure, the client module 131 may transmit result information obtained by executing the plurality of actions according to the plan to the intelligent server 201. The intelligent server 201 may confirm that the received voice input has been correctly processed through the result information.

According to an embodiment of the disclosure, the client module 131 may include a voice recognition module. According to an embodiment of the disclosure, the client module 131 may recognize a voice input that performs a limited function through the voice recognition module. For example, the client module 131 may execute an intelligent app for processing a voice input for performing a systematic operation through a designated input (e.g., wake up).

According to an embodiment of the disclosure, the intelligent server 201 may receive information related to a user voice input from the UE 101 through a communication network. According to an embodiment of the disclosure, the intelligent server 201 may convert data related to the received voice input into text data. According to an embodiment of the disclosure, the intelligent server 201 may generate a plan for performing a task corresponding to the user voice input based on the text data.

According to an embodiment of the disclosure, the plan may be generated by an AI system. The AI system may be a rule-based system, a neural network-based system (e.g., a feedforward neural network (FNN)), or a recurrent neural network (RNN). Alternatively, the AI system may be a combination thereof or an AI system different therefrom. According to an embodiment of the disclosure, the plan may be selected from a set of predefined plans or may be generated in real time in response to a user request. For example, the AI system may select at least one plan from a plurality of predefined plans.

According to an embodiment of the disclosure, the intelligent server 201 may transmit a result obtained according to the generated plan to the UE 101, or may transmit the generated plan to the UE 101. According to an embodiment of the disclosure, the UE 101 may display the result obtained according to the plan on the display 160. According to an embodiment of the disclosure, the UE 101 may display a result obtained by executing an operation according to the plan on the display 160.

The intelligent server 201 according to an embodiment of the disclosure may include a front end 210, a natural language platform 220, a capsule DB 230, an execution engine 235, an end user interface 240, a management platform 245, a big data platform 250, and an analytic platform 255.

According to an embodiment of the disclosure, the front end 210 may receive a voice input received from the UE 101. The front end 210 may transmit a response corresponding to the voice input.

According to an embodiment of the disclosure, the natural language platform 220 may include an automatic speech recognition (ASR) module 221, a natural language understanding (NLU) module 223, a planner module 225, a natural language generator (NLG) module 227, and a text-to-speech (TTS) module 229.

According to an embodiment of the disclosure, the ASR module 221 may convert a voice input received from the UE 101 into text data. According to an embodiment of the disclosure, the NLU module 223 may determine user's intention by using the text data of the voice input. For example, the NLU module 223 may determine the user's intention by performing syntactic analysis or semantic analysis. According to an embodiment of the disclosure, the NLU module 223 may determine the meaning of a word extracted from a voice input by using linguistic features (e.g., grammatical elements) of a morpheme or phrase, and may match the determined meaning of the word to the intention, thereby determining the user's intention.

According to an embodiment of the disclosure, the planner module 225 may generate a plan using the intention determined by the NLU module 223 or a parameter. According to an embodiment of the disclosure, the planner module 225 may determine a plurality of domains required for performing a task based on the determined intention. The planner module 225 may determine a plurality of actions included in each of the plurality of domains determined based on the above-mentioned intention. According to an embodiment of the disclosure, the planner module 225 may determine a parameter used to execute the determined plurality of actions or a result value output by the execution of the plurality of actions. The parameter and the result value may be defined as a concept related to a designated type (or class). Thus, the plan may include the plurality of actions determined by the user's intention and a plurality of concepts. The planner module 225 may determine a relationship between the plurality of actions and the plurality of concepts in a stepwise manner (or hierarchical manner). For example, the planer module 225 may determine the execution order of the plurality of actions determined according to the user's intention based on the plurality of concepts. In other words, the planner module 225 may determine the execution order of the plurality of actions based on parameters used for the execution of the plurality of actions and results output by the execution of the plurality of actions. Accordingly, the planner module 225 may generate a plan including association information (e.g., ontology) between the plurality of actions and the plurality of concepts. The planner module 225 may generate a plan using information stored in the capsule DB 230 in which a set of the relationships between the concepts and the actions is stored.

According to an embodiment of the disclosure, the NLG module 227 may convert designated information into information in a text form. The information converted in the text form may be in the form of natural language utterance. The TTS module 229 according to an embodiment of the disclosure may convert the information in the text form into information in a voice form.

According to an embodiment of the disclosure, the capsule DB 230 may store information on a relationship between a plurality of concepts and a plurality of actions corresponding to a plurality of domains. For example, the capsule DB 230 may store a plurality of capsules including a plurality of action objects (or action information) and a concept object (or concept information) of the plan. According to an embodiment of the disclosure, the capsule DB 230 may store the plurality of capsules in the form of a concept action network (CAN) 270. According to an embodiment of the disclosure, the plurality of capsules may be stored in a function registry included in the capsule DB 230.

According to an embodiment of the disclosure, the capsule DB 230 may include a strategy registry that stores strategy information used when a plan corresponding to a voice input is determined. The strategy information may include, when there are a plurality of plans corresponding to the voice input, reference information for determining one plan. According to an embodiment of the disclosure, the capsule DB 230 may include a follow-up registry that stores follow-up action information for suggesting a follow-up action to a user in a designated situation. The follow-up action may include, for example, a follow-up utterance. According to an embodiment of the disclosure, the capsule DB 230 may include a layout registry that stores layout information of information output through the UE 101. According to an embodiment of the disclosure, the capsule DB 230 may include a vocabulary registry that stores vocabulary information included in capsule information. According to an embodiment of the disclosure, the capsule DB 230 may include a dialogue registry that stores information on dialogue (or interaction) with a user.

According to an embodiment of the disclosure, the capsule DB 230 may update the stored object through a developer tool. The developer tool may include, for example, a function editor for updating the action object or the concept object. The developer tool may include a vocabulary editor for updating vocabulary. The developer tool may include a strategy editor for generating and registering a strategy for determining a plan. The developer tool may include a dialog editor for generating a conversation with a user. The developer tool may include a follow-up editor that can activate a follow-up goal and edit a follow-up utterance providing a hint. The follow-up goal may be determined based on a currently configured goal, user preferences, or an environmental condition.

According to an embodiment of the disclosure, the capsule DB 230 may be implemented even within the UE 101. In other words, the UE 101 may include the capsule DB 230 that stores information for determining an action corresponding to the voice input.

According to an embodiment of the disclosure, the execution engine 235 may obtain a result by using the generated plan. According to an embodiment of the disclosure, the end user interface 240 may transmit the obtained result to the UE 101. Accordingly, the UE 101 may receive the result and may provide the received result to the user. According to an embodiment of the disclosure, the management platform 245 may manage information used by the intelligent server 201. According to an embodiment of the disclosure, a big data platform 250 may collect data of a user. According to an embodiment of the disclosure, the analytic platform 255 may manage quality of service (QoS) of the intelligent server 201. For example, the analytic platform 255 may manage the components and processing speed (or efficiency) of the intelligent server 201.

According to an embodiment of the disclosure, the service server 260 may provide a designated service (e.g., food order or hotel reservation) to the UE 101. According to an embodiment of the disclosure, the service server 260 may be a server operated by a third party. For example, the service server 260 may include a first service server 261, a second service server 262, and/or a third service server 263 operated by different third parties. According to an embodiment of the disclosure, the service server 260 may provide the intelligent server 201 with information for generating a plan corresponding to the received voice input. The provided information may be stored, for example, in the capsule DB 230. In addition, the service server 260 may provide the intelligent server 201 with result information according to the plan.

In the integrated intelligence system 20 described above, the UE 101 may provide a variety of intelligent services to the user in response to a user input. The user input may include, for example, an input through a physical button, a touch input, or a voice input.

According to an embodiment of the disclosure, the UE 101 may provide a voice recognition service through an intelligent app (or voice recognition app) stored therein. In this case, for example, the UE 101 may recognize a user utterance or voice input received through the microphone 173 and may provide a service corresponding to the recognized voice input to the user.

According to an embodiment of the disclosure, the UE 101 may perform a designated operation by itself or together with the intelligent server 201 and/or the service server 260 based on the received voice input. For example, the UE 101 may execute an app corresponding to the received voice input and may perform the designated operation through the executed app.

According to an embodiment of the disclosure, when the UE 101 provides a service together with the intelligent server 201 and/or the service server 260, the UE 101 may use the microphone 173 to detect a user utterance, and may generate a signal (or voice data) corresponding to the detected user utterance. The UE 101 may transmit the voice data to the intelligent server 201 using the communication interface 210.

According to an embodiment of the disclosure, in response to the voice input received from the UE 101, the intelligent server 201 may generate a plan for performing a task corresponding to the voice input or a result obtained by executing an action according to the plan. The plan may include, for example, a plurality of actions for performing a task corresponding to a voice input of a user and a plurality of concepts related to the plurality of actions. The concept may be obtained by defining a parameter input to the execution of the plurality of actions or a result value output by the execution of the plurality of actions. The plan may include association information between the plurality of actions and the plurality of concepts.

The UE 101 according to an embodiment of the disclosure may receive the response using the communication interface 210. The UE 101 may output a voice signal generated inside the UE 101 to the outside using the speaker 230 or may output an image generated inside the UE 101 to the outside using the display 240.

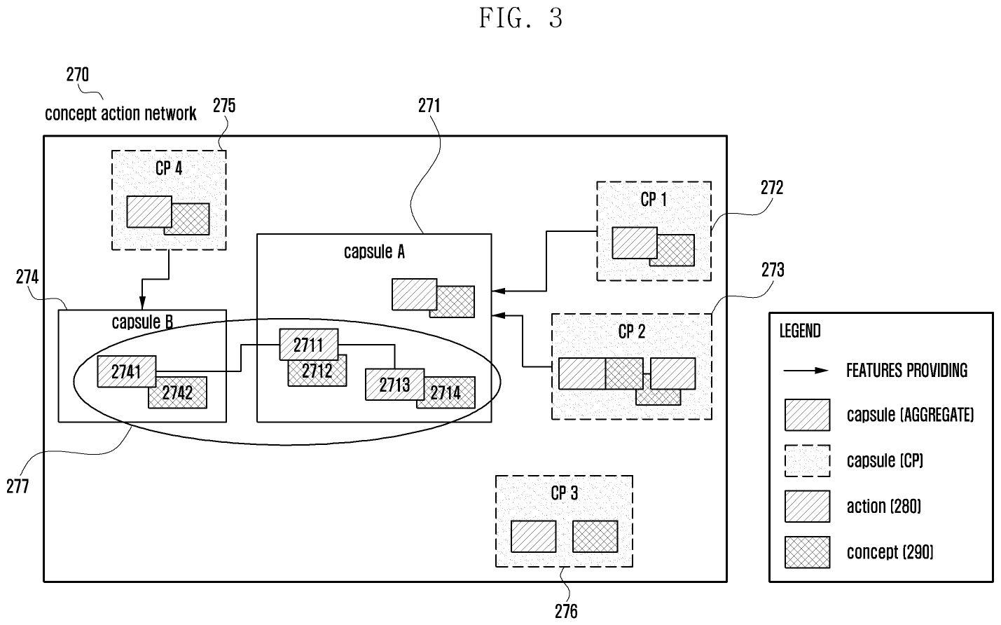

FIG. 3 is a diagram illustrating relationship information between a concept and an action being stored in a database according to an embodiment of the disclosure.

The capsule DB (e.g., the capsule DB 230) of the intelligent server 201 may store a plurality of capsules in the form of a CAN 270. The capsule DB 230 may store an action for processing a task corresponding to a voice input of a user, and a parameter used for the action in the form of the CAN 270. The CAN 270 may represent a systematic relationship between the action and a concept defining the parameter used to perform the action.

The capsule DB may store a plurality of capsules (e.g., Capsule A 271 and Capsule B 274) corresponding to each of a plurality of domains (e.g., applications) 277. According to an embodiment of the disclosure, one capsule (e.g., Capsule A 501) may correspond to one domain (e.g., an application). In addition, one capsule may correspond to at least one service provider (e.g., CP 1 272, CP 2 273, CP 3 276, or CP 4 275) to perform the function of the domain associated with the capsule. According to an embodiment of the disclosure, one capsule may include at least one or more actions 510 and at least one or more concepts 520 to perform a designated function.

Referring to FIG. 3, according to an embodiment of the disclosure, the natural language platform 220 may generate a plan for performing a task corresponding to a received voice input using a capsule stored in the capsule DB. For example, the planner module 225 of the natural language platform (e.g., the natural language platform 220) may generate a plan using a capsule stored in the capsule DB. For example, a plan 507 may be generated using actions 5011 and 5013 and concepts 5012 and 5014 of Capsule A 501 and actions 5041 and concepts 5042 of Capsule B 502.

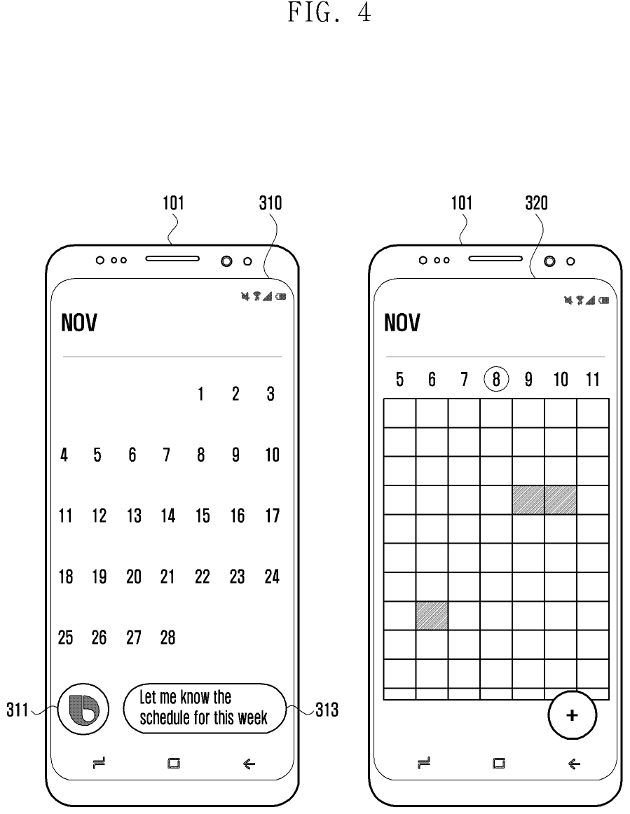

FIG. 4 is a diagram illustrating a screen in which a UE processes a voice input received through an intelligent app according to an embodiment of the disclosure.

According to an embodiment of the disclosure, the UE 101 may execute an intelligent app to process a user input through the intelligent server 201.

Referring to FIG. 4, according to an embodiment of the disclosure, on a screen 310, when the UE 101 recognizes a designated voice input (e.g., wake up!) or receives an input through a hardware key (e.g., a dedicated hardware key), the UE 101 may execute an intelligent app for processing the voice input. For example, the UE 101 may execute the intelligent app in a state where a schedule app is executed. According to an embodiment of the disclosure, the UE 101 may display an object (e.g., an icon) 311 corresponding to the intelligent app on the display 240. According to an embodiment of the disclosure, the UE 101 may receive a voice input by user utterance. For example, the UE 101 may receive a voice input of “let me know this week's schedule!”. According to an embodiment of the disclosure, the UE 101 may display, on the display 240, a user interface (UI) 313 (e.g., an input window) of an intelligent app on which text data of the received voice input is displayed.

According to an embodiment of the disclosure, on the display 320, the UE 101 may display a result corresponding to the received voice input on the display 240. For example, the UE 101 may receive a plan corresponding to the received user input, and may display “this week schedule” on the display 240 according to the plan.

The electronic device 101 according to embodiments of the disclosure may be one of various types of electronic devices, such as a portable communication device (e.g., a smartphone), a computer device, a portable multimedia device, a portable medical device, a camera, a wearable device, or a home appliance. However, the electronic devices are not limited to those described above.

It should be appreciated that various embodiments and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise.

As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., over wires), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment of the disclosure, the module may be implemented in a form of an application-specific integrated circuit (ASIC).

Various embodiments as set forth herein may be implemented as software (e.g., the program 140) including one or more instructions that are stored in a storage medium (e.g., an internal memory 136 or an external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment of the disclosure, a method according to various embodiments may be included and provided in a computer program product. The computer program product may be traded as a product between a seller and a buyer. The computer program product may be distributed in the form of a machine-readable storage medium (e.g., a compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as a memory of the manufacturer's server, a server of the application store, or a relay server.

According to various embodiments of the disclosure, each component (e.g., a module or a program) of the aforementioned components may include a single entity or multiple entities. According to various embodiments of the disclosure, one or more of the aforementioned components may be omitted, or one or more other components may be added. Alternatively or additionally, a plurality of components (e.g., modules or programs) may be integrated into a single component. In such a case, according to various embodiments of the disclosure, the integrated component may still perform one or more functions of each of the plurality of components in the same or similar manner as they are performed by a corresponding one of the plurality of components before the integration. According to various embodiments of the disclosure, operations performed by the module, the program, or another component may be carried out sequentially, in parallel, repeatedly, or heuristically, or one or more of the operations may be executed in a different order or omitted, or one or more other operations may be added.

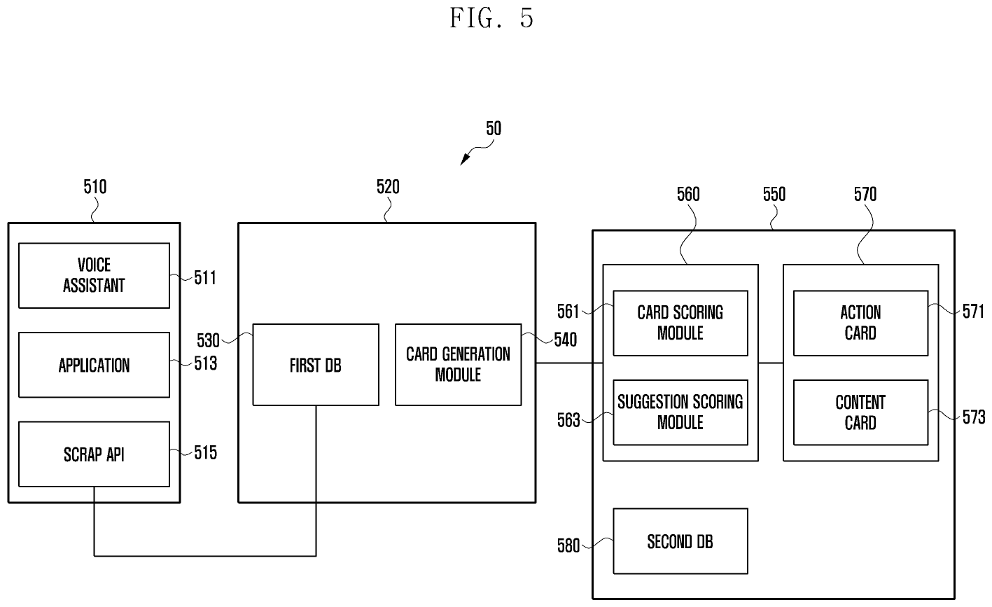

FIG. 5 is a diagram illustrating a system which provides an information card in an electronic device according to an embodiment of the disclosure.

According to an embodiment of the disclosure, FIG. 5 may illustrate an example of system architecture in which the electronic device 101 displays, on a display (e.g., the display device 160 in FIG. 1 or the display 240 in FIG. 2), a user interface (UI) (e.g., a UI about a first application program) including a scrap object (or the scrap interface), obtains user intent-based information based on a user input using the scrap object, generates an information card based on the obtained user intent-based information, and adds (or sets) the generated information card to (or in) a personalized page (e.g., a personal page interface).

Referring to FIG. 5, the system 50 according to various embodiments may include an assistant module 510, a semantic analysis module 520, and an interface providing module 550.

The assistant module 510 according to an embodiment may include a voice assistant 511, an application 513 or a scrap application program interface (API) 515, for example. According to an embodiment of the disclosure, the assistant module 510 may illustrate a module for providing an interface (e.g., a scrap object or a scrap interface) capable of obtaining (or scraping) information meaningful to a user in an application program. For example, the assistant module 510 may provide related information (e.g., an API or a software development kit (SDK)) capable of constructing an interface capable of scraping content of a user to a content provider (CP) (or a third party or an application program developer) about an application program (e.g., the voice assistant 511, the application 513 or the scrap API 515).

The semantic analysis module 520 according to an embodiment may illustrate a module for interpreting corresponding content based on a meaning of scraped content and providing semantic information (or scrap information) (e.g., information related to a task based on the results of execution of the task). According to an embodiment of the disclosure, the semantic analysis module 520 may analyze a rule indicating how content (and/or intent) has been constructed, and may obtain semantic information about the rule. The semantic analysis module 520 according to an embodiment may include a first database (DB) 530 and a card generation module 540, for example.

According to an embodiment of the disclosure, the first DB 530 may store scrap information (or semantic information) scraped by a user. According to an embodiment of the disclosure, the card generation module 540 may generate a card (or an information card) by using scraped content information and add (or arrange) the generated card in a personal page interface.

According to an embodiment of the disclosure, the interface providing module 550 may illustrate a module for adding (or arranging), in a personal page interface, a card generated in the semantic analysis module 520. The interface providing module 550 according to an embodiment may include a scoring module 560, a personal page interface module 570, and a second DB 580, for example.

According to an embodiment of the disclosure, the scoring module 560 may illustrate a module for identifying a score for the arrangement or proposal of a card. According to an embodiment of the disclosure, the scoring module 560 may perform scoring on a card, may identify whether to display each card, display timing of each card and/or a display order of each card based on the results of the scoring, and may provide a user with a corresponding card in a notification form based on corresponding display timing for each card. The scoring module 560 according to an embodiment may include a card scoring module 561 and/or a suggestion scoring module 563, for example.

According to an embodiment of the disclosure, the card scoring module 561 is a module for identifying whether to display a card added to a personal page interface and a display order of the card, and may identify whether to display the card and the display order based on scoring based on a user behavior pattern, for example. According to an embodiment of the disclosure, the card scoring module 561 may infer a score of a card based on accumulated information based on a user behavior pattern, and may identify whether to display the card, display timing of the card and/or a display order of the card based on an inferred score value. A card scoring method according to an embodiment is described with reference to drawings to be described later.

According to an embodiment of the disclosure, the suggestion scoring module 563 may illustrate a module for suggesting an optimal card (and/or semantic information) related to an occasion of a user in a card added to a personal page interface. According to an embodiment of the disclosure, the suggestion scoring module 563 may infer a score of a card based on the setting of a user and/or a trained behavior pattern of a user, and may identify whether to suggest the card and/or a suggestion order by using an inferred score value.

According to an embodiment of the disclosure, the personal page interface module 570 may illustrate a module for providing a personal page interface by including (or adding) at least one card (e.g., an action card 571 and/or a content card 573).

According to an embodiment of the disclosure, the second DB 580 may store user context information. According to an embodiment of the disclosure, the user context information may include information on a user. For example, the user context information may include information on an emotional state of a user. The information on an emotional state may include information related to an emotion, such as happiness, sadness or angriness of a user, for example. For another example, the user context information may include information on a current state of a user. The information on a current state may include information on an interest or intent (e.g., shopping or play), for example.

The electronic device 101 according to various embodiments of the disclosure includes a display (e.g., the display device 160 in FIG. 1 or the display 240 in FIG. 2), at least one processor (e.g., the processor 120 in FIG. 1 or the processor 260 in FIG. 2) operatively coupled to the display, and a memory (e.g., the memory 130 in FIG. 1) operatively coupled to the processor. The memory is configured to store a first application program including a first UI and a second application program including a second UI. The memory may store instructions, when being executed, enabling the processor to receive a first user input that requests a task using the first application program, to display, on the display, the first UI including the results of the execution of the task, to receive a second user input that stores the task, to store, in the memory, information related to the task based on at least some of the second user input, to receive a third user input that executes the second application program after storing the information, and to show, in some region of the second UI, the stored information related to the task in response to the third user input.

According to various embodiments of the disclosure, the information related to the task may include at least one of a uniform resource identifier (URI) or a command related to the task.

According to various embodiments of the disclosure, the information related to the task may include content related to the results of the execution of the task.

According to various embodiments of the disclosure, the instructions may enable the processor to re-execute the stored task after receiving the third user input and to show, in some region of the second UI, content related to the results of the re-executed task.

According to various embodiments of the disclosure, the instructions may enable the processor to re-execute the stored task before receiving the third user input after storing the information related to the task and to show, in some region of the second UI, content related to the results of the re-executed task.

According to various embodiments of the disclosure, the instructions may enable the processor to display a scrap object for obtaining the information related to the task and to receive the first user input based on the scrap object, through at least some region of the first UI about the first application program.

According to various embodiments of the disclosure, the instructions may enable the processor to obtain the information related to the task based on the first user input, to generate a card based on the information related to the task, and to add the card to at least some region of the second UI of the second application program.

According to various embodiments of the disclosure, the instructions may enable the processor to score the generated card, to identify display timing of the card based on the results of the scoring, and to provide notification of the card based on the display timing of the card.

According to various embodiments of the disclosure, the information related to the task may include semantic-based information personalized for a user and scraped based on explicit intent of the user in the first UI.

According to various embodiments of the disclosure, the instructions may enable the processor to obtain information related to the task by using a learning model trained using an artificial intelligence (AI) algorithm.

According to various embodiments of the disclosure, the instructions may enable the processor to obtain the information related to the task by using a learning model trained using at least one of machine learning, a neural network, genetic, deep learning or a classification algorithm as AI algorithms.

According to various embodiments of the disclosure, operations described hereinafter and performed in the electronic device 101 may be executed by at least one processor of the electronic device 101 (e.g., at least one processor including a processing circuit, for example, the processor 120 in FIG. 1 or the processor 260 in FIG. 2) (hereinafter referred to as the “processor 120”). According to an embodiment of the disclosure, operations performed in the electronic device 101 may be executed by instructions which are stored in a memory (e.g., the memory 130 in FIG. 1) and, when being executed, enable the processor 120 to operate.

According to various embodiments of the disclosure, the electronic device 101 may include a display (e.g., the display device 160 in FIG. 1 or the display 240 in FIG. 2), at least one processor 120 operatively coupled to the display, and a memory (e.g., the memory 130 in FIG. 1) operatively coupled to the processor 120. According to an embodiment of the disclosure, the memory may be configured to store a first application program (e.g., an application program of a content provider (or a third party) or another application program other than a second application program of the electronic device 101) including a first UI, and the second application program (e.g., an intelligence application program or an intelligence assistant application program) including a second UI.

According to various embodiments of the disclosure, the processor 120 may perform an operation related to constructing and providing personalized semantic-based information to a user by using a learning model trained using an AI algorithm. According to an embodiment of the disclosure, the processor 120 may identify (or predict) intent of a user by using a learning model trained using an AI algorithm, may generate personalized semantic-based information based on the intent of the user, may generate an information card based on the personalized semantic-based information, may add the information card to a personal page interface and/or may identify (or predict) timing at which the user requires the information card.

According to an embodiment of the disclosure, the processor 120 may perform an operation related to constructing and providing personalized semantic-based information to a user by using at least one of machine learning, a neural network, genetic, deep learning or a classification algorithm as AI algorithms, for example.

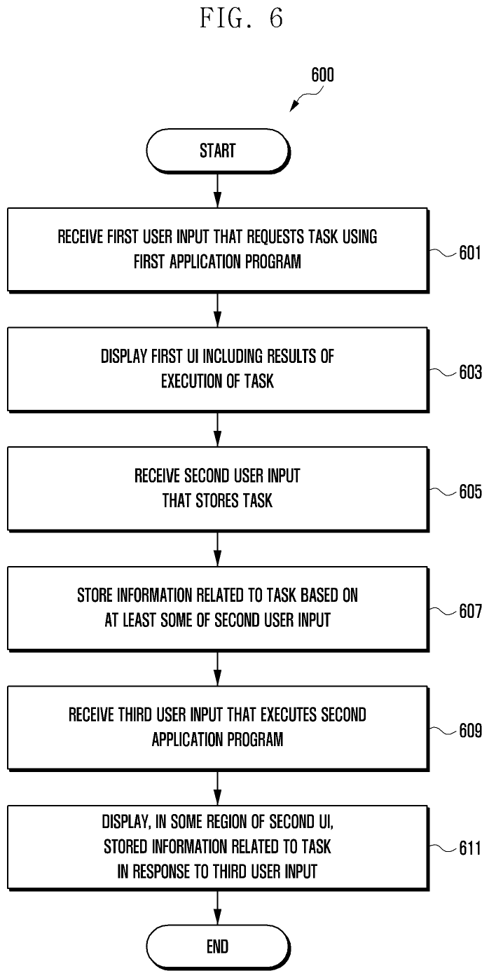

FIG. 6 is a flowchart 600 illustrating an operating method of an electronic device according to an embodiment of the disclosure.

Referring to FIG. 6, at operation 601, the processor 120 of the electronic device 101 may receive a first user input that requests a task using a first application program.

At operation 603, the processor 120 may display, on a display, a first UI including the results of execution of the task.

At operation 605, the processor 120 may receive a second user input that stores the task.

At operation 607, the processor 120 may store, in a memory, information related to the task based on at least some of the second user input. According to an embodiment of the disclosure, the information related to the task may include at least one of an address (e.g., a uniform resource identifier (URI)) or a command related to the task. According to an embodiment of the disclosure, the information related to the task may include content related to the results of the execution of the task.

At operation 609, the processor 120 may receive a third user input that executes a second application program after storing the information related to the task. According to an embodiment of the disclosure, when or after storing the information related to the task in the memory, the processor 120 may receive the third user input related to the execution of the second application program.

At operation 611, the processor 120 may display, in some region of a second UI, the stored information related to the task in response to the third user input. According to an embodiment of the disclosure, after receiving the third user input, the processor 120 may re-execute the stored task, and may display, in some region of the second UI, content related to the results of the re-executed task. According to an embodiment of the disclosure, before receiving the third user input after storing the information related to the task, the processor 120 may re-execute the stored task and display, in some region of the second UI, the content related to the results of the re-executed task.

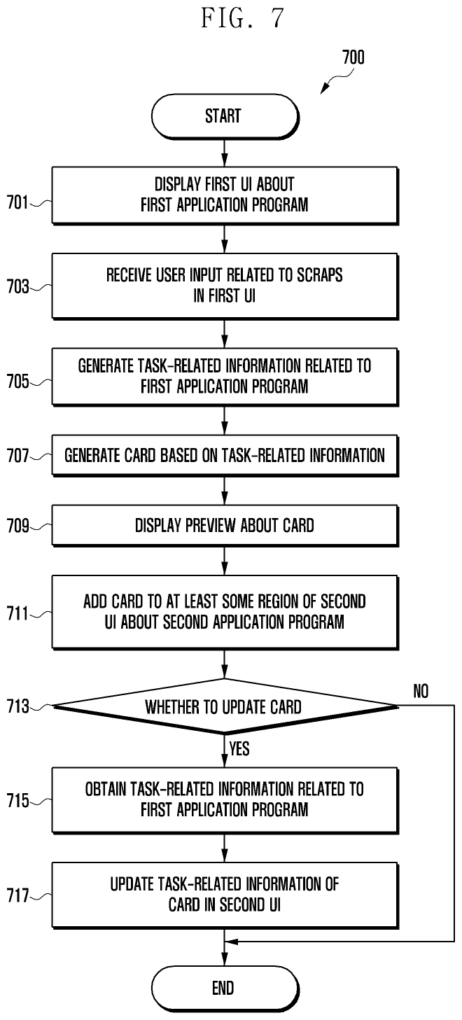

FIG. 7 is a flowchart 700 illustrating an operating method of an electronic device according to an embodiment of the disclosure.

Referring to FIG. 7, at operation 701, the processor 120 of the electronic device 101 may display, on a display, a first UI about a first application program. According to an embodiment of the disclosure, the first UI may provide (or display), through at least some region of the first UI, a scrap object (or a scrap interface) capable of obtaining (or scraping) information meaningful to a user.

At operation 703, the processor 120 may receive a user input related to scraps in the first UI. According to an embodiment of the disclosure, the user input related to scraps may be an input (e.g., a scrap object touch input or a voice input) related to a scrap object provided through the first UI. According to an embodiment of the disclosure, the user input related to scraps may be a designated input (e.g., a touch gesture input or a voice input) for scraps based on the first UI, for example.

At operation 705, the processor 120 may generate task-related information related to the first application program. According to an embodiment of the disclosure, the processor 120 may predict intent of the user in the first UI based on at least some of the user input, may perform a task about the predicted intent of the user (e.g., scrap content (or an interested item)) based on the first application program, and may generate a result (e.g., task-related information) of the execution of the task in the first application program.

At operation 707, the processor 120 may generate a card (e.g., an information card or an interface having a card form) based on the task-related information. According to an embodiment of the disclosure, the processor 120 may scrap content (or an interested item) obtained based on the first UI about the first application program, may predict intent of the user based on scraped content information (e.g., scrap information), may generate semantic information according to the intent of the user based on the prediction, and may generate an information card (or an interface having a card form) capable of visually providing the user with the semantic information. According to an embodiment of the disclosure, the semantic information may include information obtained (or collected) from content (or an interested item) included in the first application program (or a first UI about the first application program) based on the results of prediction after predicting (or identifying) intent of a user by using a learning model trained using an AI algorithm, for example. According to an embodiment of the disclosure, the operation of generating the card based on the task-related information is described with reference to drawings to be described later.

At operation 709, the processor 120 may display a preview about the card. According to an embodiment of the disclosure, the processor 120 may display, as a preview, an information card (or an interface having a card form) including semantic information through the first UI (or a second UI (e.g., a personal page interface) about a second application program according to a screen change). According to an embodiment of the disclosure, the operation of displaying a preview at operation 709 may not be performed, and the process may proceed to operation 711 and operations subsequent to operation 711 may be performed. For example, the processor 120 may not display a preview about a card depending on option setting of the electronic device 101 by a user. In other words, operation 709 may be selectively performed or may not be performed.

At operation 711, the processor 120 may add the card to at least some region of a second UI (e.g., a personal page interface or an intelligent assistant (e.g., Bixby, Google assistant or Home of Siri playing a role of an intelligent virtual secretary) about the second application program. According to an embodiment of the disclosure, the processor 120 may add (or arrange) a generated card at a proper location between at least one card (e.g., previously generated information cards) about personalized semantic-based information of a user included in the second UI.

According to an embodiment of the disclosure, the arrangement (or displayed timing and/or order) of the card in the second UI (e.g., a personal page interface) may be set by explicit selection of a user, may be automatically identified and set based on a trained learning model (e.g., a behavior pattern of a user), or may be automatically identified and set based on scoring based on a trained learning model (e.g., a behavior pattern of a user), for example. According to an embodiment of the disclosure, designing the arrangement of a card based on a condition (e.g., a condition related to whether to display the card and order) in which the card is arranged is described with reference to drawings to be described later. According to an embodiment of the disclosure, the processor 120 may provide the user with the second UI (e.g., a personal page interface) including at least one card based on a user input that executes the second application program by displaying the second UI on the display. According to an embodiment of the disclosure, the processor 120 may score a generated card, and may identify display timing of the card based on the results of the scoring. According to an embodiment of the disclosure, the processor 120 may provide the user with the card in a notification form based on the display timing of the card.

At operation 713, the processor 120 may identify whether to perform updates about the card. According to an embodiment of the disclosure, the processor 120 may identify whether updates about content (e.g., semantic information) constructing the card are necessary. According to an embodiment of the disclosure, the updates about the card may be identified as updates of the card at a corresponding location, place or occasion (or when a condition for the updates is satisfied), when content (or semantic information) is changed based on the use of the second application program by the user, when a user input for scraps is received again in the second UI, or when content (or semantic information) is information (e.g., weather information, location information, notification information, or environment information) that needs to be updated based on a location, place or occasion of a user.

The processor 120 may terminate the aforementioned operation when the updates about the card are not identified (e.g., “No” at operation 713) at operation 713, and may then process a related operation based on a user input (e.g., an operation of the electronic device 101 based on a manipulation of the user).

When the updates about the card are identified (e.g., “Yes” at operation 713) at operation 713, at operation 715, the processor 120 may obtain information about the card based on the first application program. According to an embodiment of the disclosure, the processor 120 may obtain (or collect) content (or semantic information) related to the card through the first application program (or a content provider (or content server) of the first application program).

At operation 717, the processor 120 may update task-related information of the corresponding card in the second UI based on the obtained information of the card. According to an embodiment of the disclosure, the processor 120 may update the card by changing an object (e.g., an object corresponding to the task-related information) provided through the card so that the object corresponds to the updated task-related information.

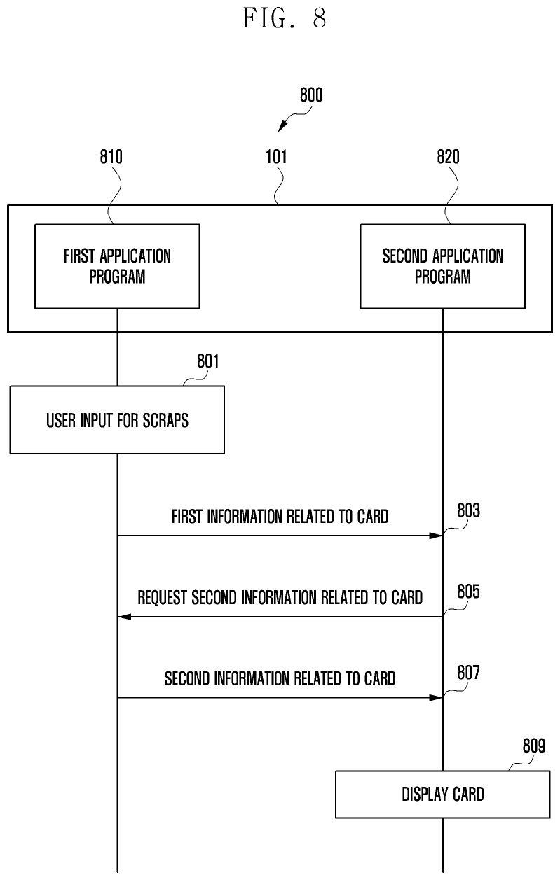

FIG. 8 is a diagram illustrating interactions between applications in an electronic device according to an embodiment of the disclosure.

Referring to FIG. 8, it illustrates an example 800 of operations performed between a first application program 810 and a second application program 820 installed in the electronic device 101 in relation to adding, to an intelligent assistant, content (e.g., semantic information) interested by a user.

According to an embodiment of the disclosure, the first application program may be an application program of a content provider (or a third party) or may include another application program, such as a voice assistant, other than the second application program of the electronic device 101, for example. For example, the first application program may include an application program which provides a user with content (or data) related to the first application program through a designated first UI.

According to an embodiment of the disclosure, the second application program may be an intelligence application program or may include an intelligence assistant application program, for example. For example, the second application program may include an application program which provides a user with at least one card constructed based on scraped content information (or semantic information) (e.g., information related to a task) through a designated second UI (e.g., a personal page interface or the home of an intelligent assistant) in response to an explicit intent of the user. For example, the second application program is an application program playing a role of an intelligent virtual secretary, and may illustrate an intelligent assistant, such as Bixby, Google assistant or Siri, for example.

Referring to FIG. 8, at operation 801, the first application program 810 may receive a user input for scraps. According to an embodiment of the disclosure, the processor 120 of the electronic device 101 may execute the first application program whose execution is requested by a user, and may display, on a display, a designated first UI about the first application program. According to an embodiment of the disclosure, the first UI may include at least one scrap object (or scrap interface) divided for each piece of constructed (or provided) content. According to an embodiment of the disclosure, the first application program 810 may receive a user input that requests a task (e.g., scraps) based on a scrap object. According to an embodiment of the disclosure, the processor 120 may identify the reception of the user input based on at least some of the scrap object of the first UI about the first application program.

According to various embodiments of the disclosure, the user may request (or instruct) specific content (e.g., an interested item about intent of the user), provided by the first application program (or the first UI), to be scraped through the scrap object. According to an embodiment of the disclosure, the scrap request may be performed based on a designated voice command input, a designated touch gesture input or a motion control input of a designated electronic device 101 for a scrap function corresponding to the scrap object. For example, an interface in which the scrap function corresponding to the scrap object may be performed is not limited to a specific application program, and may be supported by a system (or the electronic device 101) in an API form and provided to various application programs or content providers within voice command systems. For example, various application program developers and voice assistant content providers (or content servers) may provide an interface (e.g., a scrap object) in which users may scrap content intended by the users through a corresponding API.

At operation 803, the first application program 810 may deliver, to the second application program 820, first information related to a card based on the user input. According to an embodiment of the disclosure, the processor 120 may deliver, to the second application program 820, the first information (e.g., information related to a task) related to the generation of the card, including the results of execution (e.g., semantic information) of a task (e.g., scraps) in the first application program 810, which may be generated in the second application program based on at least some of the user input.

According to an embodiment of the disclosure, the first information may include information for executing the task in the first application program 810, providing the user with a preview of the card based on the results of the execution of the task, and requesting the addition of the card from the second application program 820 in response to user selection. According to an embodiment of the disclosure, the first information may include information, such as a card template ID, a card address (e.g., a card URI) and/or a command (e.g., arguments), and a purpose description as in an example of Table 1 below. According to an embodiment of the disclosure, the first application program 810 may identify a template ID of a template to be used, may autonomously generate a URI capable of denoting a corresponding card based on the template, and may deliver the URI to the second application program 820. According to an embodiment of the disclosure, the first application program 810 may also deliver a description so that a purpose of the corresponding card is known.

TABLE 1

| | | |
|---|---|---|
| 1 | Card | An ID of a template in which a layout and data |
| | template | format of a card are previously defined and |
| | ID | provided, and follows a given template (or format) |
| | | when content is provided. |
| 2 | Card URI+ | A factor necessary upon query of a URI string |
| | arguments | capable of uniquely denoting card content and |
| | (optional) | specific content. |
| 3 | Purpose | A description having a meaning that a category |
| | description | of a card and the card are delivered to a user. |

According to an embodiment of the disclosure, in information related to a task, a format of a card address (e.g., a card URI related to the task) and a command (e.g., argument) may be constructed like “scheme://authority/path/cardid?arg1=value1&arg2=value2 . . . ” as in an example of Table 2 below. A portion “path” and portions subsequent to “arg1” may be optionally included.

TABLE 2

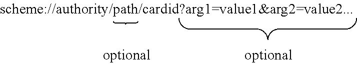

According to various embodiments of the disclosure, as exemplified in Tables 1 and 2, upon query of specific content about the first application program 810, when a factor value is necessary, a UI in which a user may select the factor value may be provided. According to an embodiment of the disclosure, although one content provider provides a plurality of cards, a UI in which a user may select the plurality of cards may be provided.

At operation 805, the second application program 820 may request second information related to the card from the first application program 810. According to an embodiment of the disclosure, the second information may include content (or semantic information) which is obtained (or collected) based on a user input in the first application program 810, for example. According to an embodiment of the disclosure, the processor 120 may store the first information (e.g., information related to the task) in the memory (e.g., the memory 130 in FIG. 1) of the electronic device 101, and may enable the first application program 810 to deliver, to the second application program 820, content related to the card. According to an embodiment of the disclosure, the second application program 820 may store the first information (e.g., information related to the task) received from the first application program 810, and may request the content from the first application program 810 (or a content provider (or server) of the first application program). According to an embodiment of the disclosure, the second application program 820 may request content about a corresponding card from the first application program 810 by using, as a factor, the first information (e.g., a card URI) received from the first application program 810.

At operation 807, the first application program 810 may deliver, to the second application program 820, the second information (e.g., content) related to the card. According to an embodiment of the disclosure, the processor 120 may enable the first application program 810 to deliver corresponding content to the second application program 820 based on a content request from the second application program 820. According to an embodiment of the disclosure, when delivering the second information, the first application program 810 may deliver the content filled according to a template definition agreement (or a defined rule).

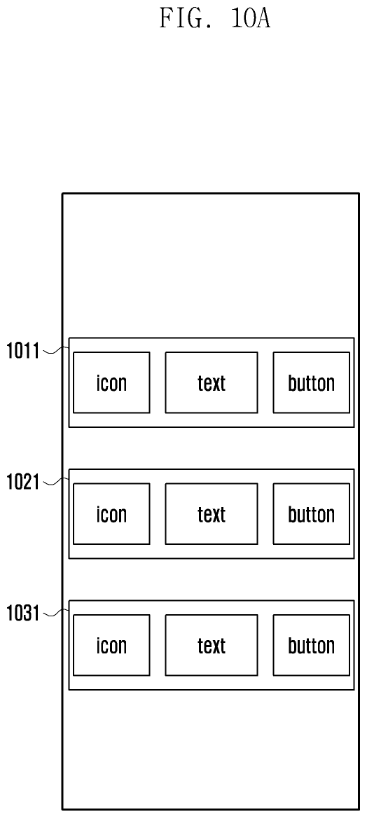

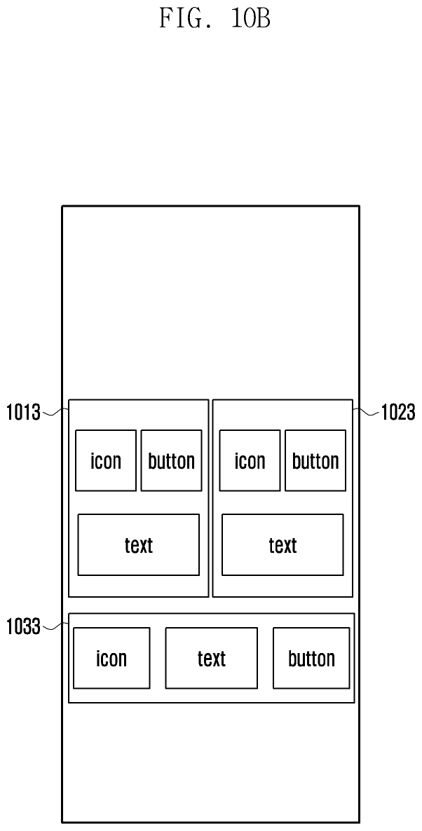

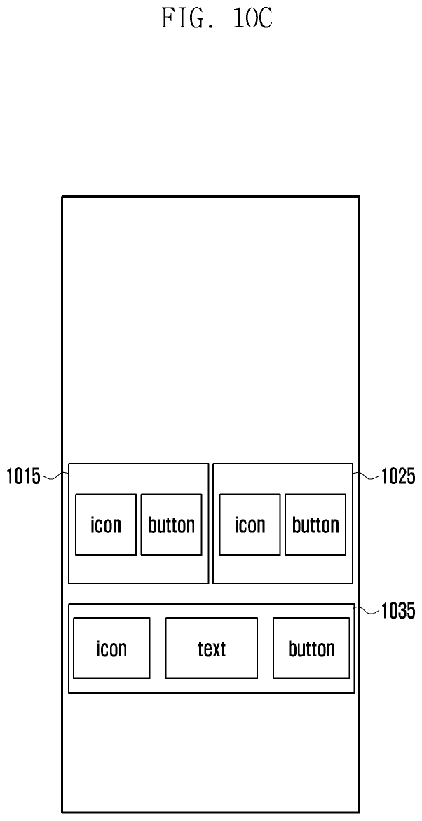

At operation 809, the second application program 820 may display the card. According to an embodiment of the disclosure, the processor 120 may enable the second application program 820 to construct and display the card including the content received from the first application program 810. According to an embodiment of the disclosure, the processor 120 may enable the card, including the content, to be constructed and displayed according to a template definition agreement (e.g., the card template ID in Table 1) previously determined between the first application program 810 and the second application program 820, and may enable the card to respond to a user behavior for the card. An example of such an operation is described with reference to FIGS. 10A, 10B, and 10C.

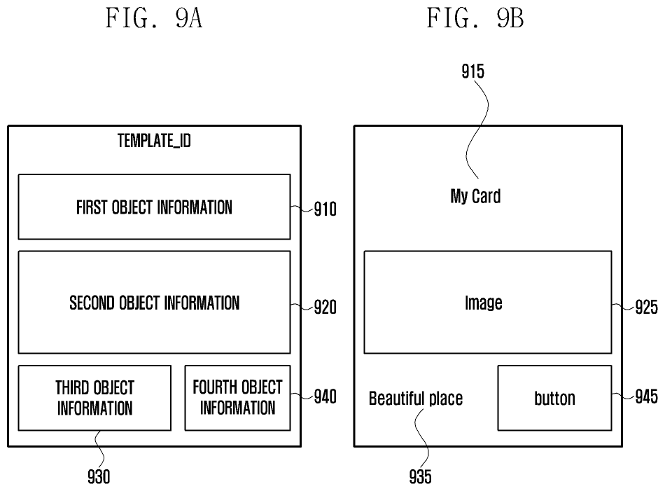

FIGS. 9A and 9B are diagrams illustrating a card being constructed in an electronic device according to an embodiment of the disclosure.

According to various embodiments of the disclosure, the processor 120 may enable a card including information related to a task of the first application program 810 to be constructed, to be displayed on a display, and to respond to a user behavior for the card, based on a template definition agreement (e.g., a card template ID) defined between the first application program 810 and the second application program 820.

Referring to FIGS. 9A and 9B, example A may illustrates an example of information related to a task, which is delivered from the first application program 810 to the second application program 820, for example. Example B may illustrate an example of a card constructed based on information related to a task, which is delivered from the second application program 820 to the first application program 810, for example.

According to various embodiments of the disclosure, information related to a task (or template definition agreement) delivered between application programs may include object information 910, 920, 930, and 940 related to various objects 915, 925, 935, 945, such as first object information 910 for a first object 915, second object information 920 for a second object 925, third object information 930 for a third object 935 or fourth object information 940 for a fourth object 945, for example.

According to an embodiment of the disclosure, information (e.g., the object information 910, 920, 930, and 940) related to a task may define a layout and a data type and/or whether to provide an action URI on which a user may perform a related function when selecting (e.g., touching) an object, along with a unique template ID about a template, for example. For example, the information related to the task may include an action URI, a remote data URI, local data and/or text.

According to an embodiment of the disclosure, the action URI may include a web page when a user selects (e.g., touches) a corresponding object, a content provider (or server) or information for enabling a jump into an application program (e.g., the first application program 810) of a content provider (e.g., move (or change) to a web page or a screen of a corresponding application program), for example, and may include a command and a factor. For example, the action URI may illustrate information on which a task may be performed.

According to an embodiment of the disclosure, the remote data URI, the local data and/or the text may illustrate information on which content may be invoked. For example, the remote data URI may include an address on which resources or data in a web or a server may be accessed and invoked. For example, the local data may include a resource image, a file or data which is present in the electronic device 101 and invoked. For example, the text may include simple text information to be displayed on a screen.

According to an embodiment of the disclosure, as illustrated in FIGS. 9A and 9B, the processor 120 may provide a first region with the first object 915 (e.g., “My Card”) on which an action is possible based on the first object information 910 (e.g., title text and an action URI), may provide a second region with the second object 925 (e.g., “Image”) on which an action is possible based on the second object information 920 (e.g., an image and an action URI), may provide a third region with the third object 935 (e.g., “Beautiful place”) based on the third object information 930 (e.g., text), and may provide a fourth region with the fourth object 945 (e.g., “button” object) on which an action is possible based on the fourth object information 940 (e.g., button information). According to an embodiment of the disclosure, the action URI may be optionally included depending on a characteristic (e.g., a characteristic that enables a jump into an associated function) of each object.

According to various embodiments of the disclosure, cards constructed (or generated) as described above and added to the second application program 820 may be provided to a user through a second UI (e.g., a personal page interface) of the second application program 820. According to various embodiments of the disclosure, a condition for whether to display the cards through the second UI, display timing of the cards and/or a display order of the cards may be set for the cards added to the second application program 820. For example, the condition for whether to display the cards, display timing of the cards and/or a display order of the cards may be set by explicit selection of a user, and may be automatically identified and set based on scoring (e.g., grading) based on a user behavior pattern. For example, the cards added to (or generated in) the second application program 820 may be scored by the scoring module 560. Display timing of the cards may be identified for each card based on a result of scoring. A corresponding card may be provided to a user in a notification form based on corresponding display timing of each card.

According to an embodiment of the disclosure, conditions which may be explicitly selected by a user may include time (e.g., absolute time, time based on a user behavior pattern (e.g., time when getting up in the morning or time before going to bed)), a place (e.g., at home or at work) or an occasion (e.g., when a specific utterance is generated), for example.

According to an embodiment of the disclosure, if whether to display the cards, display timing of the cards and/or a display order of the cards operate (e.g., automatic setting) based on scoring, a card score for each card may be inferred, whether to display the card by using the inferred score value, display timing of the card and/or a display order of the card may be identified through accumulated information based on a user behavior.

According to an embodiment of the disclosure, an example of an operation of constructing accumulated X features (e.g., common environmental information or card-specialized information) and a Y value, that is, the accumulation of user reaction results according to the X features, is described. Table 3 below illustrates an example in which the X features are common environmental information. Table 4 below may illustrate an example in which the X features are card-specialized information.

TABLE 3

| | |
|---|---|
| Time | Time when going to bed, time when getting up, time |
| | when attending office, time when coming home |
| Place | Home, office, school, favorite place, place never been |
| | to before |
| Day | Weekdays, weekend, day of the week |
| Time of Day | Morning (5 to 10), daytime (10 to 15), evening |
| | (15 to 20), night (20 to 5) |

TABLE 4

| | |
|---|---|
| Category | Category of a card |
| | e.g.,) Utility, News, Entertainment, Social, |
| | Reminder, Trends, Player |
| App usage | Frequency of use of an application program |
| | associated with a card |
| New content | Whether content is new content for a user |

According to an embodiment of the disclosure, Y, that is, user reaction results, may be accumulated by calculating, as a score, a thing seen by a user and a touch behavior of the user, for example. According to an embodiment of the disclosure, more weight may be assigned to a touch, that is, a positive behavior of a user. If a calculation equation is configured based on the weight, the calculation equation may be illustrated as in an example of Equation 1 below.

Score Y=Max(6×C,(1+2V)×(1−D))+1 Equation 1

In Equation 1, a factor “C” may indicate whether a user has performed a touch (e.g., 0 or 1). A factor “V” may indicate whether the user has seen a thing (e.g., 0 or 1). A factor “D” may indicate whether the user has dismissed a card so that the card disappears (e.g., 0 or 1).

According to various embodiments of the disclosure, the electronic device 101 (or the processor 120) may be learnt (or trained) based on an AI algorithm (e.g., machine learning, a neural network, genetic, deep learning or a classification algorithm) by using data obtained (or calculated) based on a calculation equation, such as that exemplified in Equation 1, and may identify (or predict) a score about a card by using the trained learning model. According to an embodiment of the disclosure, as exemplified in Table 5 below, the electronic device 101 (or the processor 120) may be trained by a machine learning algorithm by using data obtained by Equation 1, may infer a Y value (Yscore) of an X value (e.g., X features (e.g., time, place, occurrence (TPO)) given for each user occasion based on corresponding calculated vectors “W” and “B”, and may use the Y value as a score of the card. According to an embodiment of the disclosure, Table 5 below may illustrate an example of a case where n X features and k cards are present.

TABLE 5

| | | |
|---|---|---|
| $\begin{matrix}Feature vector X \\ ( n \text{-} dimension )\end{matrix} [ \begin{matrix}x 1 \\ x 2 \\ x 3 \\ . \\ . \\ {x}_{n}\end{matrix} ]$ | $\begin{matrix}Model parameter ( weight ) \\ matrix W ( k x n )\end{matrix} [ \begin{matrix}w 1 , 1 & w 1 , 2 … & w 1 , n \\ w 2 , 1 & & \\ w 3 , 1 & & \\ . & & \\ . & & \\ wk , 1 & … & wk , n\end{matrix} ]$ | $\begin{matrix}Bias vector B \\ ( k \text{-} dimension )\end{matrix} [ \begin{matrix}b 1 \\ b 2 \\ b 3 \\ . \\ . \\ bk\end{matrix} ]$ |

W · X + B [symbol] $[ \begin{matrix}P ( y = 1 ) \\ P ( y = 2 ) \\ . . \\ . \\ P ( y = k )\end{matrix} ] = {Y}_{p} ( Probabilities )$
Loss function: Cross-entropy (Y_{score} and Yp)

According to an embodiment of the disclosure, it may be assumed that three cards (e.g., a card A, a card B, and a card C) are given as in Table 6 below, a collected Y value (Yscore) is given as in Table 7 below, and a total of six sets as data set samples is given as in Table 8 below.

TABLE 6
Card A = ID: 100 = [1 0 0]
Card B = ID: 200 = [0 1 0]
Card C = ID: 300 = [0 0 1]

TABLE 7
Card A 3
Card B 2
Card C 1

TABLE 8
[TPO Card ID]
1) TPO 100
2) TPO 100
3) TPO 100
4) TPO 200
5) TPO 200
6) TPO 300

According to an embodiment of the disclosure, a predicted Y may define a hypothesis as “Y predict=WX+B” based on the above assumption as exemplified in Table 4. In this case, initial values of W and B may be randomly set. According to an embodiment of the disclosure, assuming that the results of the conversion of a data set 1 (e.g., TPO 100) in Table 8 into SoftMax, such as Equation 2 below, are equal to “[0.5 0.3 0.2]”, for example, a loss function (e.g., Lossfunction H_{y}(y)=−Σᵢy′log(y)) may be represented as in Equation 3 below.

$$\begin{matrix} SoftMax = P ( y = k \vert X = {x}_{i} ) = \frac{{e}^{{s}_{k}}}{{\sum }_{j} {e}^{{s}_{j}}} , s = f ( {x}_{i} ; W ) & Equation 2 \\ [ \begin{matrix}1 & 0 & 0\end{matrix} ] \times [ \begin{matrix}( 0.5 ) & ( 0.3 ) & ( 0.2 )\end{matrix} ] ( elementwise product ) \\ {H}_{c a r d A} = - ( 1 \times log ( 0.5 ) + 0 \times log ( 0.3 ) + 0 \times log ( 0.2 ) ) & Equation 3\end{matrix}$$

For example, in the case of the card A, when an occurrence probability of the card A is “1”, the H is identified as “0” (log(1)=0), and it may be determined that they match. In other words, cross entropy of the data set 1 may be −log(0.5). If Hs of six samples are calculated and added by repeating such an operation, the calculation of the cross entropy may be completed. According to an embodiment of the disclosure, learning may be performed in a way to minimize the cross entropy. According to an embodiment of the disclosure, learning may be performed in a way to change W as a value that minimizes a loss, for example. For example, a minimum value may be calculated using a gradient descendent method, and learning may be performed while changing W.

According to various embodiments of the disclosure, pieces of information constituting one card experiences a semantic analysis process, for example, and association and importance of the card may be identified based on the corresponding information. According to an embodiment of the disclosure, pieces of information constituting a card may have a plurality of purposes or intent words. Both independent semantics and complex semantics may be used for analysis.

According to various embodiments of the disclosure, pieces of information generated as described above may have different importance depending on a degree required by a user. According to an embodiment of the disclosure, in order to make different importance of pieces of information, various types of user information, such as context information of a user, for example, information on time, a place, an occasion or an event, an application program of the user and/or information on the use of a voice assistant, may be used.

According to various embodiments of the disclosure, according to an operation, such as that exemplified above, an output (e.g., a card including semantic information) corresponding to a user may be finally provided to the user through a personal page interface. An example in which a card is provided through a personal page interface is illustrated in FIGS. 10A, 10B, and 10C.

FIGS. 10A, 10B, and 10C are diagrams illustrating cards being provided through a personal page interface in an electronic device according to various embodiments of the disclosure.

Referring to FIGS. 10A, 10B, and 10C, they illustrate examples in which cards are provided in a personal page interface. Cards may be provided as card interface types having various formats in response to user setting or depending on an occasion. For example, FIGS. 10A, 10B, and 10C may illustrate examples of card interfaces having various formats, which relate to three cards (e.g., a card A, a card B, and a card C), for example.

According to an embodiment of the disclosure, FIG. 10A is an example of a card interface, and may illustrate an example of a card interface having a first format, in which each of a card A 1011, a card B 1021, and a card C 1031 includes objects (e.g., an icon, text, or a button) about information related to a task and the objects (e.g., an icon, text, or a button) have a horizontal array, for example. According to an embodiment of the disclosure, FIG. 10A may illustrate an example in which the card A 1011, the card B 1021, and the card C 1031 are vertically arranged (or disposed) in a designated order.

According to an embodiment of the disclosure, FIG. 10B is an example of a card interface, and may illustrate an example of a card interface having a second format in which each of a card A 1013, a card B 1023, and a card C 1033 includes objects (e.g., an icon, text, or a button) about information related to a task and the objects (e.g., an icon, text, or a button) of each of the card A 1013 and the card B 1023 have horizontal and vertical arrays and having the first format in which the objects (e.g., an icon, text, or a button) of the card C 1033 have a horizontal array, for example. According to an embodiment of the disclosure, FIG. 10B may illustrate an example in which the card A 1013 and the card B 1023 are horizontally arranged and the card C 1033 is arranged vertically to the card A 1013 and the card B 1023.

According to an embodiment of the disclosure, FIG. 10C is an example of a card interface, and may illustrate an example of a card interface having a third format in which each of a card A 1015 and a card B 1025 includes some objects (e.g., an icon or a button) about information related to a task and the some objects (e.g., an icon, or a button) have a horizontal array and having the first format in which a card C 1035 includes objects (e.g., an icon, text, or a button) about information related to a task and the objects (e.g., an icon, text, or a button) have a horizontal array, for example. According to an embodiment of the disclosure, FIG. 10C may illustrate an example in which the card A 1015 and the card B 1025 are horizontally arranged and the card C 1035 is arranged vertically to the card A 1015 and the card B 1025. Various embodiments are not limited to the formats of card interfaces illustrated in FIG. 10A, 10B or 10C. In addition to the formats of card interfaces, card interfaces having various formats may be used.

Referring to FIG. 10A, 10B or 10C, according to various embodiments of the disclosure, a card having a form including related content and an action which may be directly executed based on a purpose or intent of a user, not a memo pad form in which a user simply scraps and stores fixed information, can be provided. According to various embodiments of the disclosure, the contents of elements constituting a layout about a card of a personal page interface may be continuously updated with content received from an application program (e.g., the first application program 810) depending on an occasion. According to various embodiments of the disclosure, a layout about a card of a personal page interface may be manually set by a user or may be assigned weight.

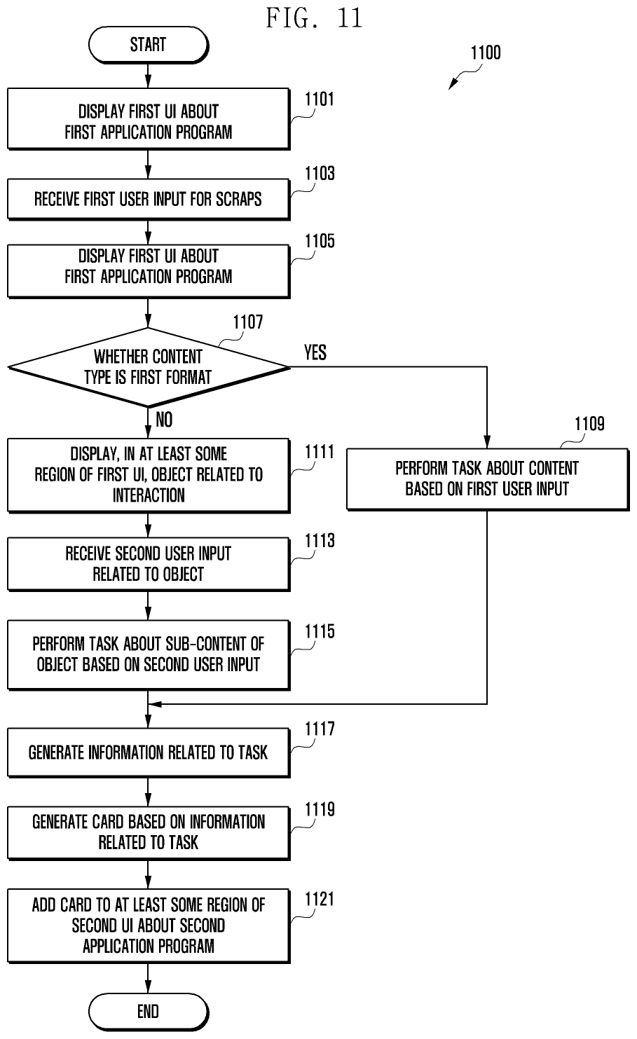

FIG. 11 is a flowchart 1100 illustrating an operating method of an electronic device according to an embodiment of the disclosure.

Referring to FIG. 11, at operation 1101, the processor 120 of the electronic device 101 may display a first UI about the first application program on a display. According to an embodiment of the disclosure, the first UI may display, in at least some region of the first UI, a scrap object (or a scrap interface) capable of scraping (or obtaining) content (or semantic information) meaningful to a user.

At operation 1103, the processor 120 may receive a first user input for scraps. According to an embodiment of the disclosure, the processor 120 may receive the user input related to scraps based on the scrap object in the first UI.

At operation 1105, the processor 120 may analyze a content type of content for which scraps have been requested. According to an embodiment of the disclosure, the content type may include a first format that does not require an interaction (or does not interact) with a user and a second format that requires an interaction with a user.

According to an embodiment of the disclosure, content having the first format may include content having a clear target and not including variable information in relation to information about a task according to scraps, like music that has recently been added or recently been heard, for example. For example, content having the first format may indicate content including a pre-defined query (or fixed content (or information)). According to an embodiment of the disclosure, content having the second format may include content in which a target is plural, such as the broadcasting of baseball game or the broadcasting of specific baseball game (e.g., baseball game of a “OO” team), as in baseball broadcasting, or content including variable information depending on a date or area (or location), such as weather information, or content in which a target (e.g., a guide date or a guide area) is plural, in relation to information about a task according to scraps, for example. For example, content having the second format may indicate content including a custom query (or variable content (or information)).

At operation 1107, the processor 120 may identify whether the content type corresponds to the first format that requires an interaction with a user or corresponds to the second format that does not require an interaction (or does not interact) with a user based on a result of the analysis of the content type. According to an embodiment of the disclosure, the processor 120 may identify content as content having the first format when the content includes a fixed and predefined query (or fixed content), and may identify content as content having the second format when the content includes a variable custom query (or variable content).

When identifying that the content type has the first format (e.g., “Yes” at operation 1107) at operation 1107, at operation 1109, the processor 120 may perform a task (e.g., scraps) about the content based on the first user input.

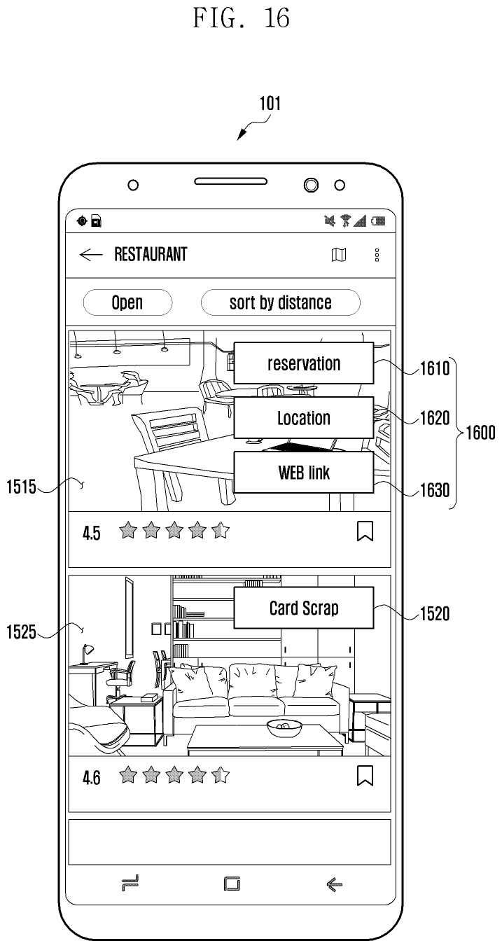

When identifying that the content type does not have the first format (or the content type has the second format) (e.g., “No” at operation 1107) at operation 1107, at operation 1111, the processor 120 may display, in at least some region of the first UI, an object (or an interface) related to an interaction. According to an embodiment of the disclosure, the processor 120 may provide (or display) a scrap object (e.g., a first scrap object) of the first UI by substituting the scrap object with at least one other scrap object (e.g., at least one second scrap object) for an interaction with a user. According to an embodiment of the disclosure, the second scrap object may be provided in accordance with sub-content (or dependent content) (e.g., the number of pieces of sub-content) which is associated with content of a scrap target and may be derived (or separated) from the content, for example. This is described with reference to FIG. 16 to be described later.

At operation 1113, the processor 120 may receive a second user input related to the object. According to an embodiment of the disclosure, the processor 120 may receive the second user input related to scraps based on any one of at least one second scrap object in the first UI.

At operation 1115, the processor 120 may perform a task (e.g., scraps) about the sub-content of the object (e.g., selected second scrap object) based on the second user input.

At operation 1117, the processor 120 may generate information related to the task, including the results of the execution of the task in operation 1109 or operation 1115.

At operation 1119, the processor 120 may generate a card (e.g., an information card or an interface having a card form) based on the information related to the task. According to an embodiment of the disclosure, the processor 120 may scrap content (or sub-content) obtained based on the first UI about the first application program, may predict intent of the user based on the scraped information (e.g., content information), may generate semantic information according to the intent of the user based on the prediction, and may generate an information card capable of visually providing the semantic information to the user. According to an embodiment of the disclosure, the semantic information may include information obtained (or collected) from content (or an interested item) included in the first application program (or the first UI about the first application program) based on the results of prediction after the intent of the user is predicted (or identified) by using a learning model trained using an AI algorithm, for example.

At operation 1121, the processor 120 may add the card to at least some region of a second UI (e.g., a personal page interface or an intelligent assistant (e.g., the home of an intelligent virtual secretary) about the second application program. According to an embodiment of the disclosure, the processor 120 may add (or arrange) the generated card at a proper location between at least one card (e.g., previously generated information cards) about personalized semantic-based information of the user included in the second UI. According to an embodiment of the disclosure, the arrangement (or displayed order) of the card in the second UI (e.g., a personal page interface) may be set by explicit selection of the user, may be automatically identified and set based on a trained learning model (e.g., a behavior pattern of the user) or may be automatically identified and set by scoring based on a trained learning model (e.g., a behavior pattern of the user), for example. According to an embodiment of the disclosure, the processor 120 may display, on a display, the second UI (e.g., a personal page interface) including at least one card based on a third user input that executes the second application program.

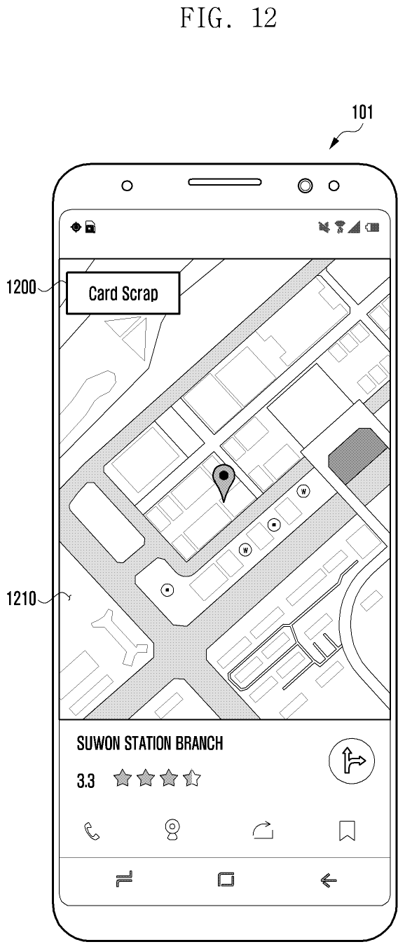

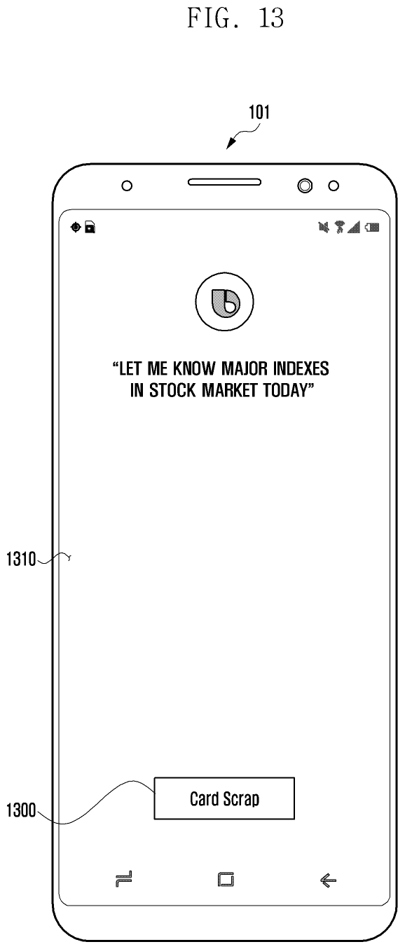

FIGS. 12, 13, and 14 are diagrams illustrating user interfaces including scrap objects according to various embodiments of the disclosure.

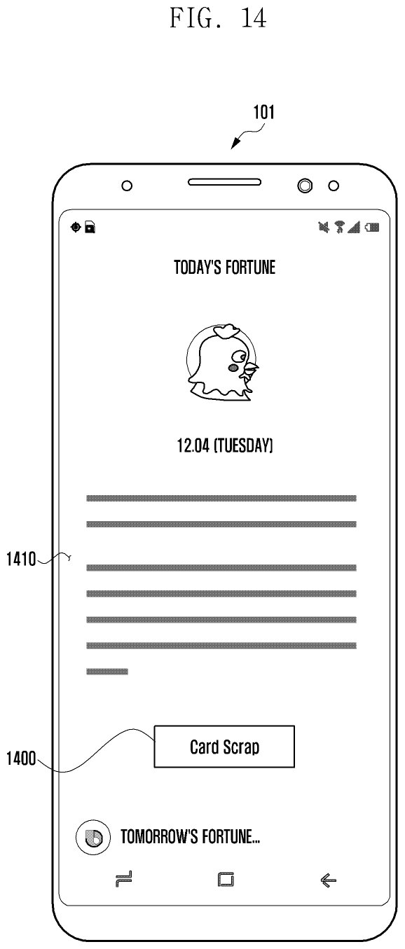

Referring to FIGS. 12, 13, and 14, the electronic device 101 may provide a scrap object 1200, 1300, 1400 through at least some region of a UI 1210, 1310, 1410 about an application program. According to an embodiment of the disclosure, the application program may be an application program (e.g., the example of FIG. 12) of a content provider (or a third party) or may include another application program of the electronic device 101, such as a voice assistant, (e.g., the example of FIG. 13 or 14). For example, the application program may include an application program which provides a user with content (or data) related to a corresponding application program through the designated UI 1210, 1310, 1410.

According to various embodiments of the disclosure, the application program may provide the UI 1210, 1310, 1410 including the scrap object 1200, 1300, 1400 in which a user may scrap content or an action.

According to an embodiment of the disclosure, referring to FIG. 12, a user may search a specific area (or place) by using an application program (e.g., a map application program). According to an embodiment of the disclosure, the application program may perform a task called “Search a map for a specific area”, and may display the results (or content) (e.g., a map (or information) of the specific area that is searched and displayed) of the task through the UI 1210. According to an embodiment of the disclosure, the application program may provide, through at least some region of the UI 1210, the scrap object 1200 in which a user may scrap an action of displaying the execution of the task and the results (e.g., content) of the execution of the task through the UI 1210. The user may generate the action about the application program as a card by scraping the action in a way to select (or touch) the scrap object 1200. According to an embodiment of the disclosure, a scrap command corresponding to the scrap object 1200 may be performed using various methods, such as a voice input, a button input or a designated touch gesture input, for example.

According to an embodiment of the disclosure, referring to FIG. 13, a user may input a voice command, such as an example of “Let me know major indexes in the stock market today”, through an application program (e.g., a voice assistant). According to an embodiment of the disclosure, the application program may perform a task called “Search for major indexes in the stock market today” in relation to the voice command, may display the results (e.g., major indexes in the stock market today) of the execution of the task through the UI 1310. According to an embodiment of the disclosure, the application program may provide, through at least some region of the UI 1310, the scrap object 1300 in which an action of displaying the execution of the task and the results of the execution of the task (e.g., performing the voice command) through the UI 1310 may be scraped. The user may generate the action about the application program as a card by scraping the action in a way to select (or touch) the scrap object 1300.

According to an embodiment of the disclosure, referring to FIG. 14, a user may input a voice command, such as an example of “Check today's fortune”, through an application program (e.g., a voice assistant). According to an embodiment of the disclosure, the application program may perform a task called “Search for today's fortune” related to the user in relation to the voice command, and may display the results (e.g., Today's fortune) of the execution of the task through the UI 1410. According to an embodiment of the disclosure, the application program may provide, through at least some region of the UI 1410, the scrap object 1400 in which an action of displaying the execution of the task and the results of the execution of the task (e.g., performing the voice command) through the UI 1410 may be scraped. The user may generate the results (e.g., content) (e.g., fortune information) themselves of the task about the application program as a card by scraping the results in a way to select (or touch) the scrap object 1400.

As in the example given with reference to FIG. 12, 13 or 14, according to various embodiments of the disclosure, the electronic device 101 may enable a user to scrap several types of intent and content by using an application program. According to various embodiments of the disclosure, the scrap object 1200, 1300, 1400 displayed through at least some region of the UI 1210, 1310, 1410 may be always displayed based on user setting, may be displayed in response to an invoking command from a user, or may be displayed depending on a setting condition (e.g., a designated application program or a designated user behavior pattern) of a user.

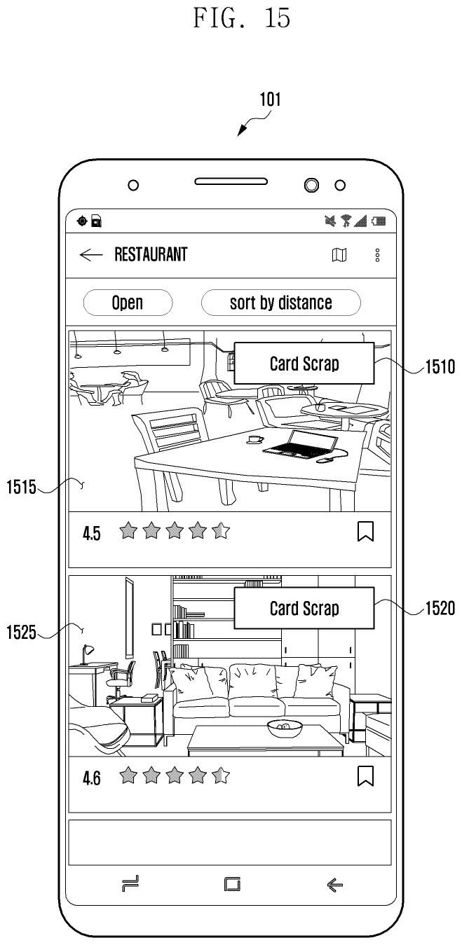

FIGS. 15 and 16 are diagrams illustrating user interfaces including scrap objects according to various embodiments of the disclosure.

Referring to FIGS. 15 and 16, the electronic device 101 may provide a user interface (UI) about an application program by dividing the UI into a plurality of sub-UIs 1515 and 1525, and may provide scrap objects 1510 and 1520 corresponding to the respective sub-UIs 1515 and 1525. According to an embodiment of the disclosure, the sub-UIs 1515 and 1525 may be divided for each type of content provided by the application program.

Referring to FIG. 15, each of the scrap objects 1510 and 1520 may be provided through at least some region of each of the first sub-UI 1515 and the second sub-UI 1525 divided from the UI of the application program for each type of content. According to an embodiment of the disclosure, each of the scrap objects 1510 and 1520 may be configured so that information (e.g., content) related to a task about content of each of the sub-UIs 1515 and 1525 is scraped. For example, if the application program provides a plurality of pieces of different contents, a user may scrap content (or information) about each of the plurality of pieces of different contents through each of the scrap objects 1510 and 1520 divided for each of the plurality of pieces of different contents.

According to an embodiment of the disclosure, the application program may include a plurality of pieces of intent and content. For example, the results of execution of a task (e.g., content having the second format) according to a user input based on the scrap object 1510 of the UI 1515 may include a plurality of pieces of sub-content. According to an embodiment of the disclosure, the content having the second format may include content in which an execution target of the task is plural. For example, the content having the second format may indicate content including a custom query (or variable content (or information)). In various embodiments of the disclosure, if a plurality of pieces of intent and content is present in an application program as described above, an additional menu (e.g., a scrap object 1600) for enabling a user to explicitly check which content will be accurately scraped may be provided. Such an example is illustrated in FIG. 16.

Referring to FIG. 16, FIG. 16 may illustrate an example in which a plurality of sub-scrap objects 1600 is provided by substituting the scrap object 1510 with the plurality of sub-scrap objects 1600 in response to a user input related to the scrap object 1510 of the sub-UI 1515 in FIG. 15, for example. For example, FIG. 16 may illustrate an example of a case where a user selects (e.g., touches) the scrap object 1510 of the first sub-UI 1515 in FIG. 15 and a corresponding scrap portion includes three types of sub-content (e.g., reservation information, location information, and WEB link information). According to an embodiment of the disclosure, the electronic device 101 may display three sub-scrap objects 1610, 1620, and 1630 for an interaction with the user by substituting the scrap object 1510 of the first sub-UI 1515 with the three sub-scrap objects 1610, 1620, and 1630 based on the three types of sub-content. According to an embodiment of the disclosure, the sub-scrap objects 1610, 1620, and 1630 may be provided in accordance with sub-content (or dependent content) (e.g., the number of pieces of sub-content) which is associated with content of a scrap target and derived (or separated) from the content, for example. For example, the electronic device 101 may provide a first sub-scrap object 1610 (e.g., reservation) for scraps about reservation information, a second sub-scrap object 1620 (e.g., Location) for scraps about location information, and a third sub-scrap object 1630 (e.g., WEB link) for scraps about a WEB link, so that the user can explicitly select which one of the three types of sub-content will be scraped. According to an embodiment of the disclosure, the sub-scrap object may additionally provide a sub-scrap object (e.g., ALL) in which all of a plurality of pieces of sub-content (or a plurality of attributes) can be scraped so that a card can be generated by scraping all of types of sub-content.

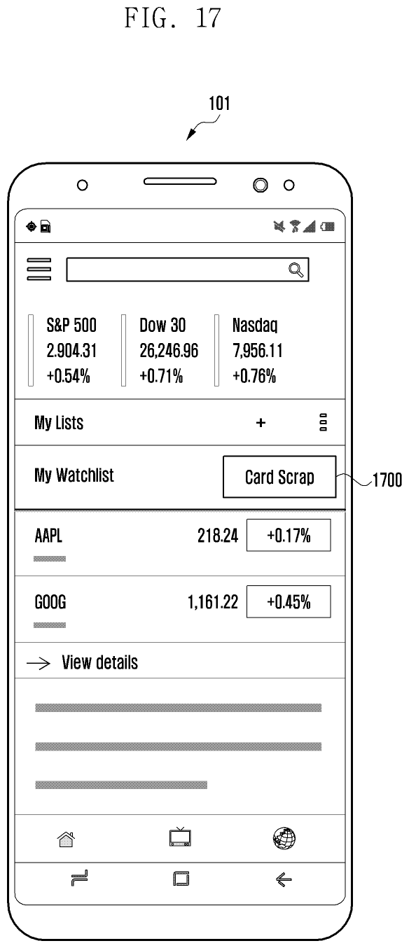

FIGS. 17, 18, and 19 are diagrams illustrating a user interface (UI) according to various embodiments of the disclosure.

Referring to FIG. 17, the electronic device 101 may provide, through at least some region of a UI about an application program, a scrap object 1700 in which a user may scrap content or an action. According to an embodiment of the disclosure, the user may select the scrap object 1700 in a watch list (e.g., My Watchlist) portion of the user by using the application program (e.g., a finance application program). According to an embodiment of the disclosure, the electronic device 101 may generate the action about the application program as a card by scraping the action based on a user input to the scrap object 1700.

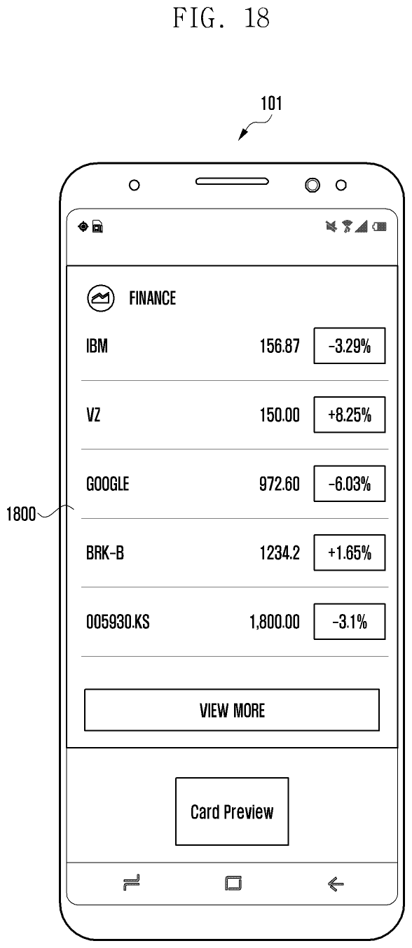

Referring to FIG. 18, according to various embodiments of the disclosure, the electronic device 101 may generate a card, and may provide the user with a preview about the card (e.g., a preview card image 1800). According to an embodiment of the disclosure, before generating the action about the application program as the card by scraping the action and then storing the card, the electronic device 101 may provide the user with a preview 1800 about the card to be generated by displaying the preview on a display. According to an embodiment of the disclosure, the preview 1800 about the card may be displayed to overlap a UI of an application program or may be displayed in a way to change a UI into a UI of an intelligence application program to which a card is substantially added and to be disposed between the changed UI (e.g., a personal page interface) and other cards, for example.

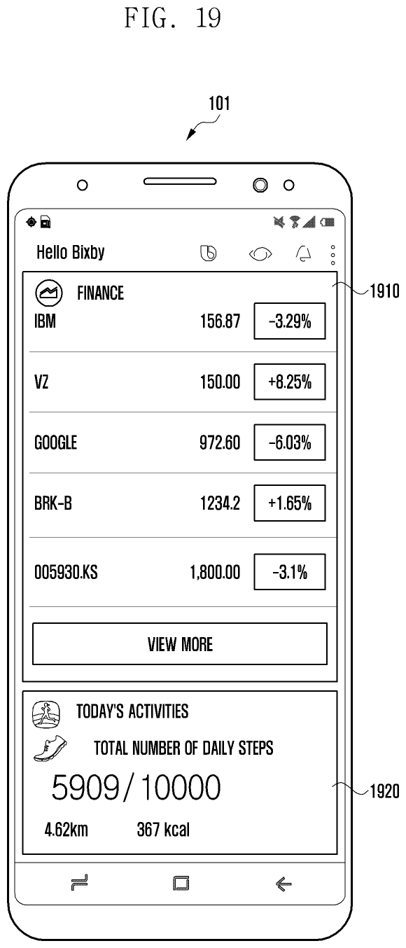

According to various embodiments of the disclosure, the user may perform a user input (e.g., a preview (1800) selection input, a check button input, a designated gesture input or a voice command input) about the generation of the card through the preview 1800 about the card. According to an embodiment of the disclosure, the electronic device 101 may generate and store a card based on the user input, and may add the corresponding card to a UI (e.g., a personal page interface) of an intelligence application program. Such an example is illustrated in FIG. 19.

Referring to FIG. 19, the electronic device 101 may add, to a personal page interface, a substantial card 1910 corresponding to the preview 1800 of FIG. 18, and may add (or arrange) the card 1910 to a corresponding location based on a relation (e.g., priority) with another card 1920 previously generated. According to an embodiment of the disclosure, the personal page interface may be displayed on a display based on a user input that executes an intelligence application program of a user. According to an embodiment of the disclosure, if several cards 1910 and 1920 are registered with the personal page interface, the user may change an order and contents of the cards as required.

According to various embodiments of the disclosure, if a plurality of pieces of intent, parameters and/or pieces of content are included in a card when the card is generated, the electronic device 101 may generate a card complexly including the plurality of pieces of intent, parameters and/or pieces of content or may generate a plurality of cards having respective characters. According to various embodiments of the disclosure, a plurality of cards having a plurality of character may be generated.

According to various embodiments of the disclosure, as exemplified in FIG. 18, when the preview 1800 about the card is provided, when the user selects the preview 1800, the electronic device 101 may provide an interface (e.g., a guide interface) about a condition provided to the user by further including the interface in the card. For example, the electronic device 101 may provide an interface in which a user may identify in which case a generated card will be provided to the user. According to an embodiment of the disclosure, the electronic device 101 may provide an interface for setting a condition, such as a context base (e.g., after getting up in the morning, before going to bed, at home or always), a touch gesture base (e.g., when an interface is drawn in a pattern on a screen), an utterance base (e.g., a specific voice input), an AI base (e.g., selected based on use pattern learning of first and second application programs) or a time base (e.g., absolute time setting) so that a user can configure an environment in which a card will be displayed.

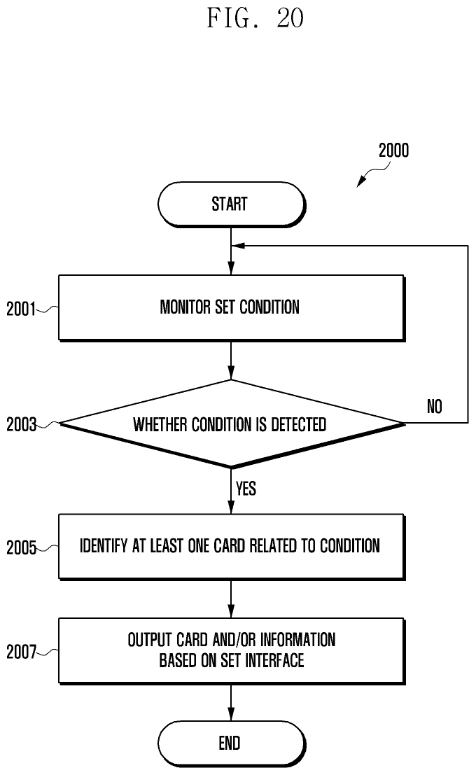

FIG. 20 is a flowchart 2000 illustrating an operating method of an electronic device according to an embodiment of the disclosure.

Referring to FIG. 20, at operation 2001, the processor 120 of the electronic device 101 may monitor a set condition about a card. According to an embodiment of the disclosure, the set condition about the card may include a condition for providing (e.g., notifying) a user with information (e.g., card and/or semantic information) scraped by the user, for example. According to an embodiment of the disclosure, the set condition about the card may include a condition based on the setting of a user and/or based on a trained behavior pattern of a user, for example. According to an embodiment of the disclosure, the processor 120 may monitor at least one condition (e.g., a designated time, a designated place, or the execution of a designated application program) designated by a user. According to another embodiment of the disclosure, the processor 120 may monitor context (e.g., time, a place (or a location), an occasion or an application program) corresponding to a card registered with an intelligence application program. For example, the processor 120 may monitor whether an application program associated with a card is executed and whether a time or place associated with a card is detected.

At operation 2003, the processor 120 may identify whether the condition is detected based on the results of the monitoring.

When the condition is not detected (e.g., “No” at operation 2003) at operation 2003, the processor 120 may proceed to operation 2001, and may perform operations subsequent to operation 2001.

When the condition is detected (e.g., “Yes” at operation 2003) at operation 2003, at operation 2005, the processor 120 may identify at least one card related to the condition. According to an embodiment of the disclosure, when the user executes (or uses) a designated application program (or associated with the card), the processor 120 may identify whether a card associated with a corresponding application program is present. According to an embodiment of the disclosure, when identifying that the user enters (or is present in) a designated specific place based on location information of the electronic device 101, the processor 120 may identify whether a card associated with the designated specific place is present. According to another embodiment of the disclosure, when an application program is executed (or used) in addition to a designated application program, the processor 120 may identify whether a card associated with the corresponding application program is present.

At operation 2007, the processor 120 may output the card and/or information based on a set interface. According to an embodiment of the disclosure, the processor 120 may display the card by overlapping the card and a UI of an application program now being executed (or being displayed) (e.g., a popup window form). According to an embodiment of the disclosure, when a state of a display is an off state (e.g., a state in which the electronic device 101 is not used), the processor 120 may display the card in a popup window form by turning on the display, and may output feedback which may be recognized by a user in relation to the popup (e.g., output vibration or a notification sound) of the card additionally or alternatively. According to an embodiment of the disclosure, when a state of a display is the off state, the processor 120 may convert semantic information about the card into an audio signal, and may provide the audio signal to a user. According to an embodiment of the disclosure, the processor 120 may output the converted audio signal through a sound output device (e.g., the sound output device 155 in FIG. 1, an earphone or a headset).

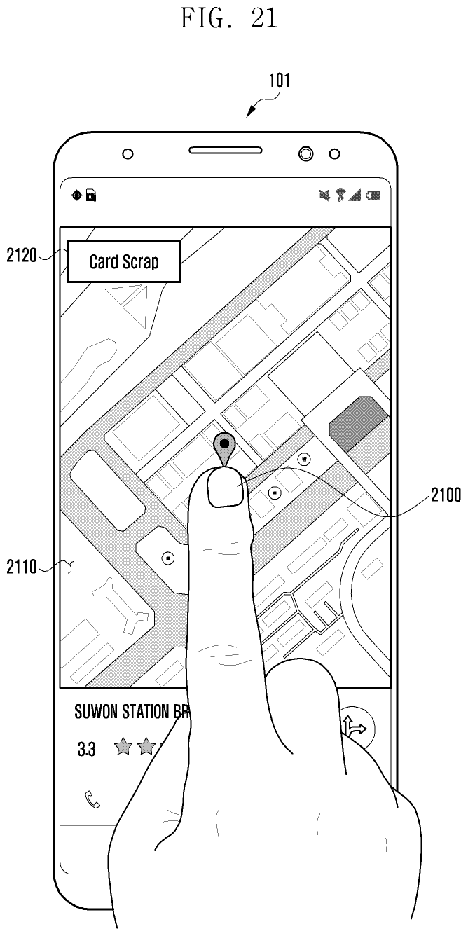

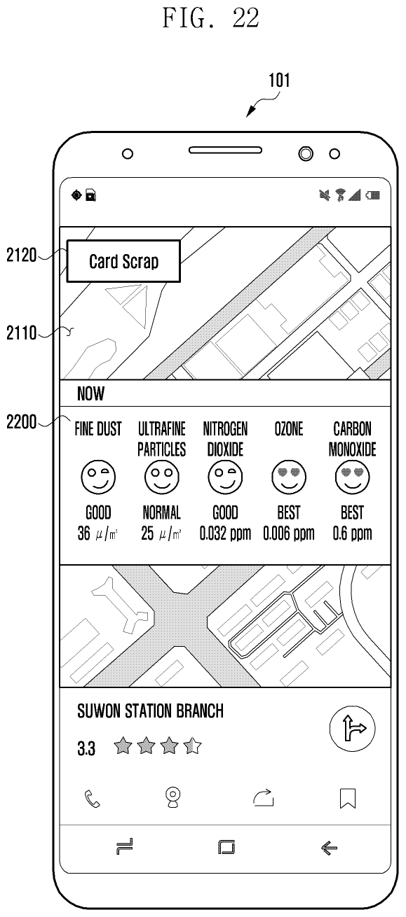

FIGS. 21 and 22 are diagrams illustrating a user interface which provides a card according to various embodiments of the disclosure.

Referring to FIGS. 21 and 22, they illustrate an example in which an interface having a form in which an optimal card (and/or semantic information) related to an occasion of a user is suggested based on information scraped by the user is provided. According to an embodiment of the disclosure, FIGS. 21 and 22 may illustrate an example in which a related card is provided through a display when the electronic device 101 monitors the execution of a designated application program and detects a set condition based on the designated application program.

According to an embodiment of the disclosure, referring to FIG. 21, a user may execute an application program (e.g., a map application program) by using the electronic device 101. According to an embodiment of the disclosure, when executing the application program, the electronic device 101 may provide a scrap object 2120 by including the scrap object 2120 in at least some region of a UI 2110 about the application program. According to an embodiment of the disclosure, the application program executed as in the example of FIG. 21 may be an application program designated to receive a card and/or related information proposed by a user, for example.

According to various embodiments of the disclosure, when detecting the execution of a designated application program, the electronic device 101 may monitor a set condition in the designated application program (e.g., a user input about the use of the application program). According to an embodiment of the disclosure, referring to FIG. 21, when executing the map application program, the electronic device 101 may monitor a user input 2100 (e.g., a set condition) for designating a location. According to an embodiment of the disclosure, when detecting a set condition (e.g., the user input 2100) based on a designated application, the electronic device 101 may extract a card about (or associated with) the designated application program (e.g., a card related to the set condition, for example, an environment information card about a designated location), and may provide the card to a user. According to an embodiment of the disclosure, referring to FIG. 22, the electronic device 101 may provide the user with the card 2200 about the designated application program by overlapping and displaying the card 2200 and at least some region of the UI 2110.

An operating method of the electronic device 101 according to various embodiments of the disclosure may include an operation of receiving a first user input that requests a task using the first application program, an operation of displaying, on a display, a first UI including the results of execution of the task, an operation of receiving a second user input that stores the task, an operation of storing, in a memory, information related to the task based on at least some of the second user input, an operation of receiving a third user input that executes a second application program after storing the information in the memory, and an operation of displaying, in some region of a second UI, the stored information related to the task in response to the third user input.

According to various embodiments of the disclosure, the information related to the task may include at least one of a uniform resource identifier (URI) or a command related to the task.

According to various embodiments of the disclosure, the information related to the task may include content related to the results of the execution of the task.

According to various embodiments of the disclosure, the operating method of the electronic device 101 may include an operation of re-executing the stored task and an operation of displaying, in some region of the second UI, content related to the results of the re-executed task, after receiving the third user input.

According to various embodiments of the disclosure, the operating method of the electronic device 101 may include an operation of re-executing the stored task and an operation of displaying, in some region of the second UI, content related to the results of the re-executed task, before receiving the third user input after storing the information related to the task.

According to various embodiments of the disclosure, the operation of receiving the first user input may include an operation of displaying, in at least some region of the first UI about the first application program, a scrap object for obtaining information related to the task and an operation of receiving the first user input based on the scrap object.

According to various embodiments of the disclosure, the operating method of the electronic device 101 may include an operation of obtaining the information related to the task based on the first user input, an operation of generating a card based on the information related to the task, and an operation of adding the card to at least some region of the second UI of the second application program.

According to various embodiments of the disclosure, the operating method of the electronic device 101 may include an operation of scoring a generated card, an operation of identifying display timing of the card based on a result of the scoring, and an operation of providing notification of the card based on the display timing of the card.

According to various embodiments of the disclosure, the information related to the task may include semantic-based information scraped based on explicit intent of the user in the first UI and personalized for the user.

According to various embodiments of the disclosure, the obtaining of the information related to the task may include an operation of obtaining the information related to the task by using a learning model trained using an AI algorithm.

According to various embodiments of the disclosure, the operation of obtaining the information related to the task may include an operation of obtaining the information related to the task by using a learning model trained using at least one of machine learning, a neural network, genetic, deep learning or a classification algorithm as the AI algorithm.

While the disclosure has been shown and described with reference to various embodiments thereof, it will be understood by those skilled in the art that various changes in form and details may be made therein without departing from the spirit and scope of the disclosure as defined by the appended claims and their equivalents.

1. An electronic device comprising:
a display;
at least one processor operatively coupled to the display; and
a memory operatively coupled to the at least one processor,
wherein the memory is configured to store a first application program comprising a first user interface (UI) and a second application program comprising a second UI, and
wherein the memory stores instructions, when being executed, enabling the at least one processor to:
receive a first user input to request a task using the first application program,
display, on the display, the first UI comprising results of execution of the task,
receive a second user input to store the task,
store, in the memory, information related to the task based on at least some of the second user input,
receive a third user input to execute the second application program after storing the information, and
display, in some region of the second UI, the stored information related to the task in response to the third user input.

2. The electronic device of claim 1, wherein the information related to the task includes at least one of a uniform resource identifier (URI) or a command related to the task.

3. The electronic device of claim 1, wherein the information related to the task includes content related to the results of the execution of the task.

4. The electronic device of claim 1, wherein the instructions further enable the at least one processor to:
re-execute the stored task before receiving the third user input after storing the information related to the task or after receiving the third user input, and
display, in some region of the second UI, content related to results of the re-executed task.

5. The electronic device of claim 1, wherein the instructions further enable the at least one processor to:
display, in at least some region of the first UI about the first application program, a scrap object for obtaining the information related to the task, and
receive the first user input based on the scrap object.

6. The electronic device of claim 5, wherein the instructions further enable the at least one processor to:
obtain the information related to the task based on the first user input,
generate a card based on the information related to the task, and
add the card to at least some region of the second UI of the second application program.

7. The electronic device of claim 6, wherein the instructions further enable the at least one processor to:
score the generated card,
identify display timing of the card based on a result of the scoring, and
provide notification of the card based on the display timing of the card.

8. The electronic device of claim 1, wherein the information related to the task includes semantic-based information scraped based on explicit intent of a user in the first UI and personalized for the user.

9. The electronic device of claim 1, wherein the instructions further enable the at least one processor to obtain the information related to the task by using a learning model trained using an AI algorithm.

10. An operating method of an electronic device, the method comprising:
receiving a first user input to request a task using a first application program;
displaying, on a display, a first user interface (UI) comprising results of execution of the task;
receiving a second user input to store the task;
storing, in a memory, information related to the task based on at least some of the second user inputs;
receiving a third user input to execute a second application program after storing the information; and
displaying, in some region of a second UI, the stored information related to the task in response to the third user input.

11. The method of claim 10, wherein the information related to the task includes at least one of a uniform resource identifier (URI) related to the task, a command or content related to results of execution of the task.

12. The method of claim 10, further comprising:
re-executing the stored task before receiving the third user input after storing the information related to the task or after receiving the third user input; and
displaying, in some region of the second UI, content related to results of the re-executed task.

13. The method of claim 10, wherein receiving a first user input comprises:
displaying, in at least some region of the first UI about the first application program, a scrap object for obtaining the information related to the task; and
receiving the first user input based on the scrap object.

14. The method of claim 13, further comprising:
obtaining the information related to the task based on the first user input;
generating a card based on the information related to the task; and
adding the card to at least some region of the second UI of the second application program.

15. The method of claim 14, further comprising:
scoring the generated card;
identifying display timing of the card based on a result of the scoring; and
providing notification of the card based on the display timing of the card.
